(19) United States
(12) Patent Application Publication
(10) Pub. No.: US 2006/0048092 A1
(43) Pub. Date: Mar. 2, 2006

(54) Object oriented mixed reality and video game authoring tool system and method

(76) Inventors: Eugene Harrison Kirkley JR., Bloomington, IN (US); Steven Christopher Borland, Bloomington, IN (US); Steven James Tomblin, Noblesville, IN (US); Andrew James Nelson, Indianapolis, IN (US); William Robert Pendleton, Bloomington, IN (US); Jamie Reaves Kirkley, Bloomington, IN (US); Lyle E. Turner, Bloomington, IN (US); Tyler Todd Waite, Bloomington, IN (US)

Correspondence Address: BAKER & DANIELS LLP, 300 NORTH MERIDIAN STREET, SUITE 2700, INDIANAPOLIS, IN, 46204, US

(21) Appl. No.: 11/216,377

(22) Filed: Aug. 31, 2005

Related U.S. Application Data
(60) Provisional application No. 60/606,154, filed on Aug. 31, 2004.

(51) Int. Cl. G06F 9/44

(52) U.S. Cl. 717/100

(57) ABSTRACT

The present invention involves a mixed reality or video game authoring tool system and method which integrates design information in the mixed reality or video game interfaces and allows the authoring of both mixed reality and video game environment and facilitates the iterative development of mixed reality and video game environments.

### CROSS-REFERENCE TO RELATED APPLICATIONS

The present claims priority under 35 U.S.C. §119(e) of U.S. Patent Provisional Application entitled MIXED AND VIRTUAL REALITY DEVELOPER ENVIRONMENT, Ser. No. 60/606,154, filed Aug. 31, 2004.

### GOVERNMENT RIGHTS

One embodiment of this invention was made with Government support under Small Business Innovation Research contract W74V8H-04-C-001 awarded by United States Army Research Institute for the Behavioral and Social Sciences. The Government has certain rights in this invention.

Source Code Appendix

This application includes a computer software listing appendix submitted on two duplicate single compact discs each having the computer software data files on the following directory: ARI-CREATESource and referenced by the file build.xml, the contents of which are incorporated by reference herein. The complete listing of files on the source code appendix compact discs are provided in Appendix B to this application. A portion of the disclosure of this patent document contains material which is the subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The invention relates to mixed reality and video game development software. More specifically, the field of the invention is that of authoring tool software for creation of mixed reality and/or video game environments.

2. Description of the Related Art

The development of computer systems has progressed from character based data processing systems to complex audio and visual modeling software. In many fields, the advance of computer technology, and particularly its output, has advanced the state of the art.

For example, in the field of training, the systematic concept of Analysis, Design, Development, Implementation, and Evaluation (“ADDIE”) of training tools has provided significant advancement in the development of computer assisted training. In the typical system, the analysis and design may specify certain types of audio and visual environments. In the development and implementation phases, specific audio and/or visual tools may be created for the purpose of the training. Finally, the evaluation phase may result in modifications to these audio and visual tools. While ADDIE is a model from the ISD field, its stages and related activities easily generalize to creation of non-instructional content and systems.

Such training tools may include “mixed reality” environments (or “MR”). In the context of this application, “mixed reality” refers to an audio, visual, haptic (touch), olfactory (smell) and/or taste environment which is presented to the user of the mixed reality computer system and to which the user may respond to within the parameters of the presentation. The creators of the “mixed reality” environment specify the several visual, auditory, touch, smell, taste, spatial, and physical models of the desired environment, possibly including actual images of physical environments, which are integrated and that “reality” is presented to the user. The output of the mixed reality computer system may include a combination of sights, sounds, touch, smell and/or taste from a native environment with additional computer generated sights, sounds, touch, smell, and/or taste (e.g., presented by mixed reality goggles or helmets and other devices). For example, when a user is presented with specific visual and audio cues, the user may move a computer mouse, activate ajoystick, move tactile sensors, or otherwise interact with the computer system to effect the presentation of the audio and/or visual environment. Thus, while the user does not have her or his entire set of senses controlled by the computer system, a portion of those senses are engaged as if the digital content were part of the real world, and the reaction of the user to the presentation of the audio and/or visual information affects subsequent presentation. Thus, the user of the system has seemingly real interaction with the presented “reality” creating the “mixed reality.” A mixed reality system can range from a low immersion system that might simply present context-specific (e.g., location) text to a person to one in which most of what the person is experienceing is a computer generated environment (e.g., a video game that uses real world props as part of the game).

Unfortunately, the application of the ADDIE technique to the complicated and detailed specification and implementation of a mixed reality or video game software system results in substantial costs in terms of time and effort in modifying and enhancing a mixed reality software system. Currently, existing instructional methodologies do not adequately address how to design and deliver learning in the context of mixed reality and virtual reality or how to move seamlessly between these modalities as well as traditional technologies within an instructional environment. Improvements in the development of such systems is needed.

### SUMMARY OF THE INVENTION

The present invention is a mixed reality and video game authoring tool system and method which allows for the iterative development of mixed reality and video games by allowing for dynamic editing of mixed reality and video game environments. Thus, the parameters of the mixed reality or video game environment may be altered while a user is within a mixed reality or video game environment and the presentation refined in response to user interaction.

One possible solution to help resolve some of these challenges is to create an authoring tool to support the design of a variety of types of learning environments from simple to complex. The present invention supports the various stages of the design process in a way that is flexible and supports iterative design, production and delivery of next generation blended learning environments using games, simulations and various other forms of mixed and virtual realities. The authoring tool of the present invention is one example of a type of tool that can be used to organize and support the design, production and delivery process. This authoring tool does not need to fully replace the existing tools that various designers/developers use, though certain embodiments may include tools that support design, production and delivery completely within the system. For instance, a current embodiment provides an organizing, shared framework for various types of individuals as they create these next generation learning environments. In this embodiment, the authoring tool is designed to primarily support the analysis and design stages with other tools being used for production of the materials and runtime delivery.

One disclosed embodiment of the present invention relates to an authoring tool to support various types of designers of a next generation learning environment, although the present invention may be adapted for more general use. Furthermore, it is designed to be modifiable so it can support development based on organization-specific design and development processes, terminology, new learning methodologies and emerging technologies. We believe that any authoring tool that is going to adequately address the demanding needs of these next generation learning environments should support this kind of flexibility. The terms training and learning, trainee and learner, and trainer and teacher are used interchangeably in this document and the figures.

The authoring tool of the present invention involves at least three primary areas: 1. Analysis that supports the identification of learning needs through needs analysis as well as other types of analyses (e.g., audience, frame factors, technologies, and resource materials); 2. Training Matrix Design that supports the translation of learning needs to outcomes/objectives as well as learning tasks and evaluation criteria for each type of audience and for each learning outcome. 3. Production Design Environment that provides multiple types of support to the various types of design processes needed to design next generation learning environments.

Some of the specific tools provided to support the process include a module designer, a storyboard designer, a scaffolding designer, and an assessment designer. The Module Designer supports a generic approach to the design of modules as well as design of modules based on specific instructional methodologies (e.g., Problem Based Embedded Training or PBET). It also enables multiple modules to be sequenced into a learning environment. These environments are usually too complex to use just generic design support tools. Designer support must be specific to the types of learning technologies and the learning methodologies being used. This includes embedded design support wizards, best practices and design guidelines. The Storyboard Designer is used to design a variety of types of media from video games to repair and maintenance job aids. For a desktop or mixed reality video game, the Storyboard Designer supports designing an interactive simulation or scenario by providing ways to describe a series of tasks, activities, and events, link them to training goals and embed evaluation methods (e.g., a timer-based evaluation event in a game). Multiple views are provided, including a branching chart as well as list view. Designer notes can be embedded throughout, and development resources can be documented and tracked as needed. The Scaffolding Designer supports the development of different types of support for learners at different levels, from novice to expert, that can be directly embedded into a simulation, game or learning activity. The Assessment Designer supports the design of performance assessments and reflection processes that are linked to specific elements of the learning environment. For example, questions can be developed to support reflection in a simulation based on specific events. Additionally, performance assessment tools for instructors to use in assessing learners on learning objectives based on events within the simulation.

Thus, some of the advantages that we see for using authoring tools for designing next generation learning environments are to: 1. Provide a way to identify, link and implement specific learning objectives within a variety of learning environments from well- to ill-structured. 2. Provide support for creating stories and linking those to learning goals as well as embedding assessment methods that are linked to each learning goal and marked by events. 3. Provide support for using specific instructional methodologies to systematically develop blending learning environments using mixed and virtual technologies as well as traditional technologies and approaches (e.g., face-to-face techniques). 4. Create a shared process and space for design teams to iteratively design and document the learning environment, whether it is a high-end simulation-based event or a more traditional Web-based learning module; 5. In cases where games are used, to help balance design tensions between fun and training by enabling different types of designers (e.g., instructional and game designers) to communicate and use a shared development process as well as interlink their purposes and designs for the learning environment.

The present invention, in one form, relates to a computer system for creating a mixed reality environment. The system comprises an asset management software program including a plurality of asset data objects relating to the mixed reality environment. Each of the asset data objects relates to at least one of a three dimensional model, an image, text, sound, haptics, taste, smell, a button, and an action setting. Also included is a project organization software program including at least one mixed reality interface. The project organization software program is capable of creating project data objects referencing asset data objects, mixed reality interfaces, and project data objects. The system also has a project editor capable of modifying the project organization software program according to operator instructions.

The present invention, in another form, is a method for generating a mixed reality environment. The method has the steps of creating a mixed reality interface, organizing the mixed reality interface into at least one project; presenting the project to a user; and editing the project based on reactions of the user to the presentation of the project.

Further aspects of the present invention involve a computer system for authoring an application for both a mixed reality environment and a video game environment. The computer system comprises an asset management software program including asset data objects relating to an environment. Each asset data object relates to at least one of a three dimensional model, an image, text, sound, haptics, taste, smell, a button, and an action setting. The system further includes an editor program for creating an environment from the asset management software program. The editor configures the environment so that the environment is usable by one or both of a mixed reality and video game device and a video game device.

Another aspect of the invention relates to a machine-readable program storage device for storing encoded instructions for a method of creating a mixed reality environment according to the foregoing method.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1A is a schematic diagrammatic view of a authoring tool using the present invention.

FIG. 1B is a schematic diagrammatic view of an instantiation of the authoring tool using the present invention.

FIG. 2 is a screen shot diagram of the general interface elements of the CREATE software in addition it describes the analysis outline screen.

FIG. 3 is a screen shot diagram of the wizard help elements that aid the user in the current user task.

FIG. 4 is a screen shot diagram of the grid view training matrix view that contains all the needs, learning objectives, and performance expectations.

FIG. 5 is a screen shot diagram of the goals and objectives view that displays all the goals and learning objectives in context of the associated learning activities.

FIG. 6 is a screen shot diagram of the storyboard tree view in which the designer can layout the story sequences in the activity.

FIG. 7 is a screen shot diagram of the instructional sequencer that allows the user order their instructional modules.

FIG. 8 is a screen shot diagram of the screen that develops the instructional aspects of one or more storyboard scenes.

FIG. 9 is a screen shot diagram of the environment editor which develops the environment of one or more storyboard scene.

FIG. 10 is a screen shot diagram of the View designer window and provides an image corresponding to the subject scene, possibly in one or more of the perspectives provided by environment editor screen.

FIG. 11 is a schematic diagram of the action plan screen which depicts the outline of an instructional activity and grouping of several instructional activities.

FIG. 12 is a screen shot diagram of the outline view training matrix view that contains all the needs, learning objectives, and performance expectations.

FIG. 13 is a screem shot diagram of the Trainer Adaptation Tool in which the trainer can modify elements of the product before and during product delivery.

FIG. 14 is a screen shot diagram of the Trainer Adaptation Tool Tab in which the user defines which elements may be modified by the trainer.

FIG. 15 is a screen shot diagram of the set up screen in which the user defines all relevant information to the product.

FIG. 16 is a screen shot diagram of the storyboard screen being used to create a sequenced job aid.

FIG. 17 is a screen shot diagram of the design document export screen in which all learning relevant issue defined in CREATE are exported to a design document.

FIG. 18 is a screen shot diagram of the production plan export screen in which all production relevant issue defined in CREATE are exported to a design document.

FIG. 19 is a screen shot diagram of the formative evaluation module.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. These descriptions and representations are the means used by those skilled in the art of data processing to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects. Objects may also be invoked recursively, allowing for multiple applications of an object's methods until a condition is satisfied. Such recursive techniques may be the most efficient way to programmatically achieve a desired result.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The terms “desktop”, “personal desktop facility”, and “PDF” mean a specific user interface which presents a menu or display of objects with associated settings for the user associated with the desktop, personal desktop facility, or PDF. When the PDF accesses a network resource, which typically requires an application program to execute on the remote server, the PDF calls an Application Program Interface, or “API”, to allow the user to provide commands to the network resource and observe any output. The term “Browser” refers to a program which is not necessarily apparent to the user, but which is responsible for transmitting messages between the PDF and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a handheld device and a desktop computer either via wires or wirelessly. Synchronization ensures that the data on both the handheld device and the desktop computer are identical.

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), personal digital cellular (“PDC”), or through packet-data technology over analog systems such as cellular digital packet data (CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces.

The authoring tool of the present invention will be described below, solely by way of example and without intent to infer limitations to the scope of the claims, in the context of generating application software for mixed reality and video game applications (collectively referred to hereinafter as “application(s)”). More specifically, an example is provided wherein the authoring tool is used to generate an application for training military personnel for various missions and operations associated with a typical military deployment. This particular disclosed embodiment exemplifies many of the characteristics of the present invention, although other characteristics and advantages are available for other embodiments. The methodology embodied in the tool described below and the exemplary structure may be used in the context of other training techniques, included but not limited to PBET, ACCEL (Accelerated Performance Enhancement Services) on-line learning, Command & Control Test Design, Context Reality Games, Assistive Technology, either as indicated below or as would be understood by a person of ordinary skill in the relevant art.

In the following description regarding such applications, several terms are used which have specific meanings in the context of the present invention. The term “asset” means information content in any storable form that relates to an element of a mixed reality environment. The term “interface” relates to a combination of reality based sensory input and computer generated or modeled sensory input for the end user that creates the “mixed reality environment” for the end user. The term “button” means an item perceived by an end user that if activated produces a further action or item in the mixed reality and video game environment. The term “action setting” means a dynamic computer generated item that is introduced into the mixed reality environment, information about the sequencing of assets in an interface, triggers for activation, specifications for swapping out components, and links to external applications or procedures. The term “project” means the information of the analysis, assessment, and design associated with the end user application along with the end user application(s) assets. The term “environment” refers to the runtime environment that provides the tools and content an end user uses to perform a task (sometimes referred to as an End User Environment or “EUE”). The user of the computer system of the invention may be referred to as a designer or developer in the role of the design phase or the production phase, while a user operating within an environment is referred to as an end user.

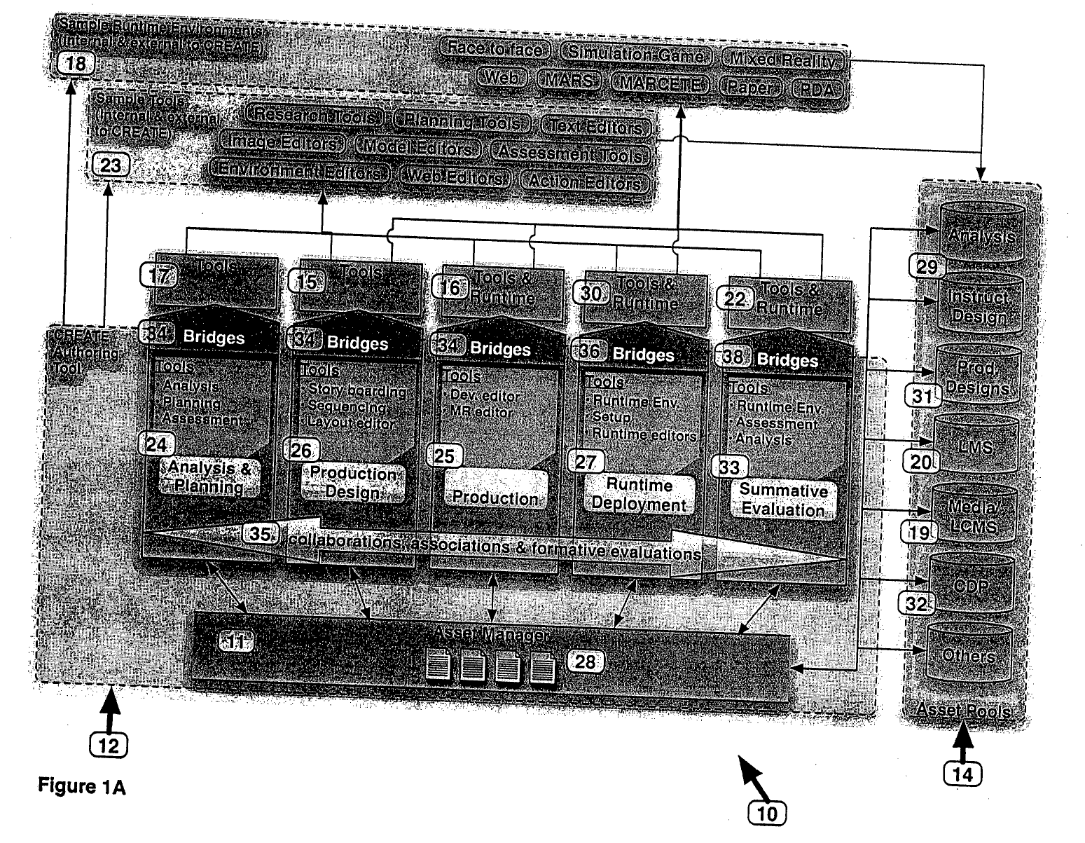

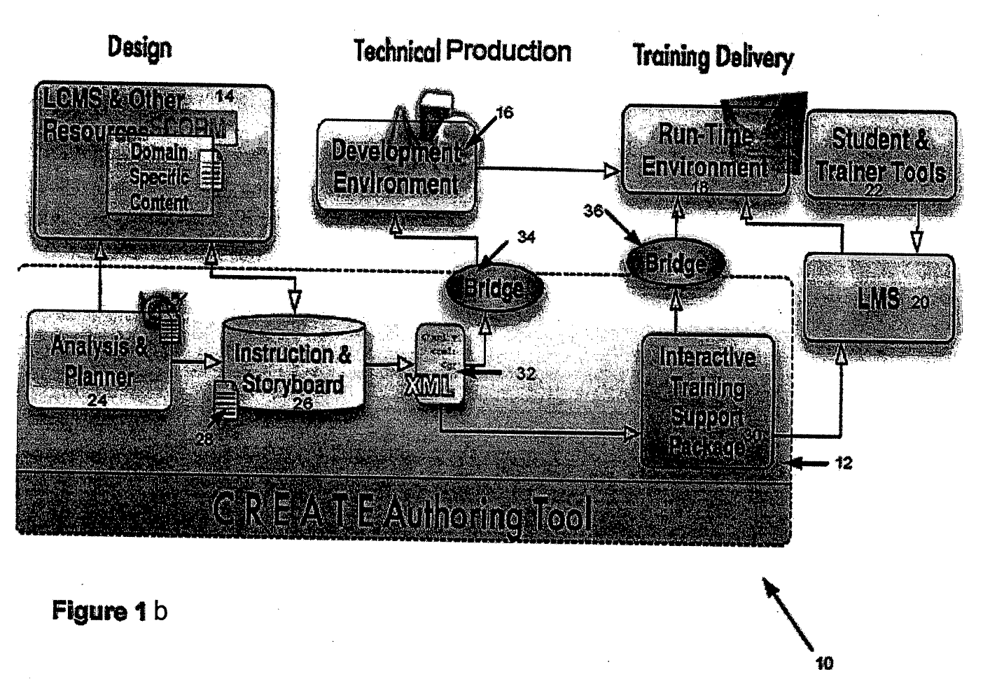

Referring now to FIG. 1A, the CREATE authoring tool 12 is comprised of five areas for authoring tool and related systems 10 that may contain tools with standard or specialized functionality depending on the need of the system at the time; Analysis & Planning 24, Production Design 26, Production 25, Runtime Deployment 27, and Summative evaluation 33. Functions that allow for collaboration, making associations and formative evaluations 35 are present throughout the tool. Authoring tool 12 consists of various bridges 34, 36, 38 that allow it to work with external tools 23 and runtime environments 18. Tool/editor bridges 34 allows authoring tool 12 to interact with external tools 23 such as editors or planning tools, runtime bridges 36 allow authoring tool 12 to interact with runtime environments 18 such as simulation-game engines, and the assessment bridges allow 38 allow authoring tool 12 to interact with external tools 23 and runtime environments 18. Authoring tool 12 may contain tools within the five areas that may replicate functions of external tools 23 or provide specialized enhancements to these tools 24, 25, 26, 27, 33. Authoring tool 12 has asset manager 11 which manages assets and projects 28 and the data that is created with either internal 24, 25, 26, 27, 33 or external tools 23. Asset manager 11 allows for interaction with external asset pools 14 and tracks the associations of assets 28, and asset manager 11 may serve as an editor. Asset pools 14 may be comprised of a multitude of resources such as media and Learning Content Management Systems 19, Learning Management Systems 20, Analysis and Instructional Design data 29, Production Design information 31 or CDP documents 32. CDP is an optional description of assets 28 and their associations 35 to each other and the project as a whole.

Referring now to FIG. 1B, one instantiation of the circumstance in which the present authoring tool may be used is depicted and which is derived from development done for the military. Systems 10 generally includes authoring tool 12, at least one asset pool or repositories of data 14, at least one external production environment 16, 25 at least one runtime environment 18, at least one optional learning management system 20, and at least one optional tool for design and runtime evaluation 22, 33. Systems 10 generally includes analysis and planning editors and wizards 17, 24, specialized editors 15, 26 and tracked assets 28, and runtime or trainer tools 27, 30. Tracked assets 28 and specialized editors 26 typically generate at least one output file 32 that may be accessed by tools for production 16, 25 from within authoring tool 12 or via a tool/editor bridge 34. Also, runtime or trainer tools 27, 30 may communicate with runtime environment 18 via a runtime bridge 36.

In accordance with one embodiment of the invention, authoring tool 12 is employed to facilitate at least three phases of an application: (1) a design phase, (2) a production phase, and (3) an end user phase as will be described in further detail below. During the design phase, authoring tool 12 assists the operator in determining the needs and/or requirements of the application. During the production phase, authoring tool 12 assists the operator in assembling and generating the content to be used by the application. During the end user phase, the application assists the system operator(s) and end user(s) in employing authoring tool 12 during use of the application to evaluate the operation of the application and modify content and/or options employed by runtime environment 18. This structure allows the system operator(s) to modify and revise the experience of the end user(s) dynamically rather than the more time consuming methods of the prior art. The combination of the details of the application implementation with the design parameters that result in the selection of that particular implementation enables the system operator(s) to modify runtime environment 18 consistently with the objectives of the original goals of the tasks.

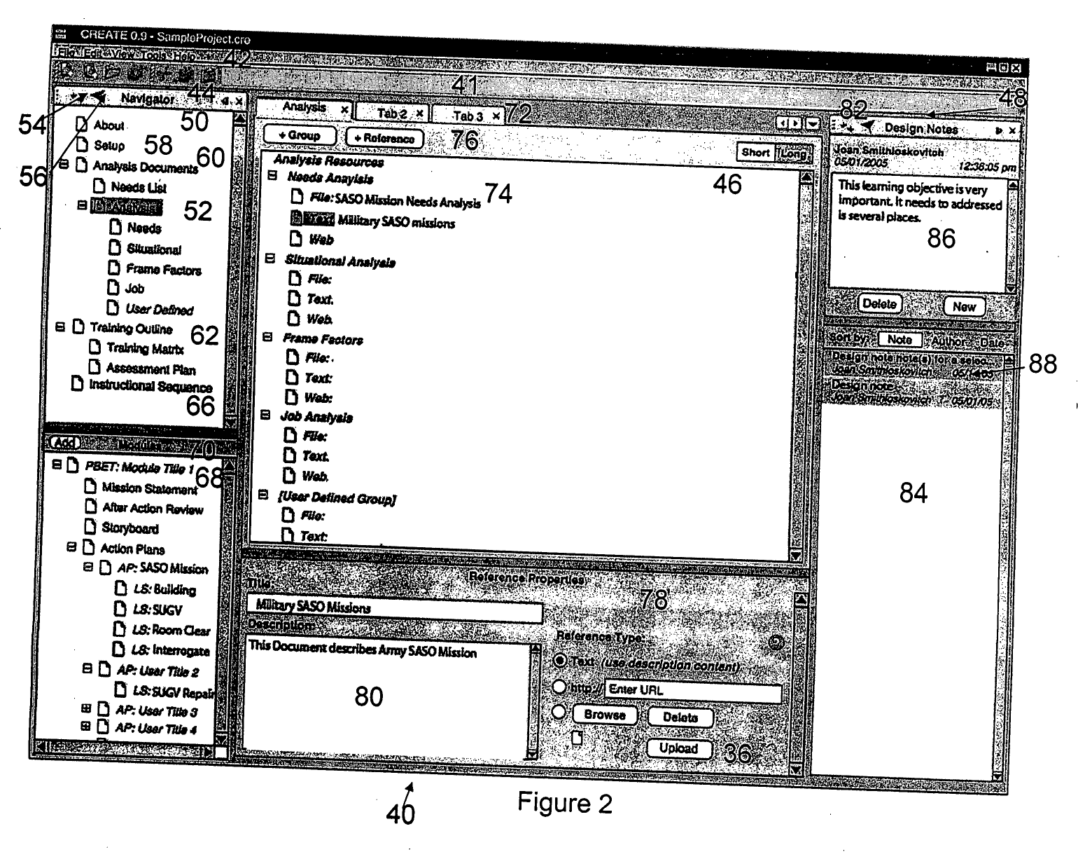

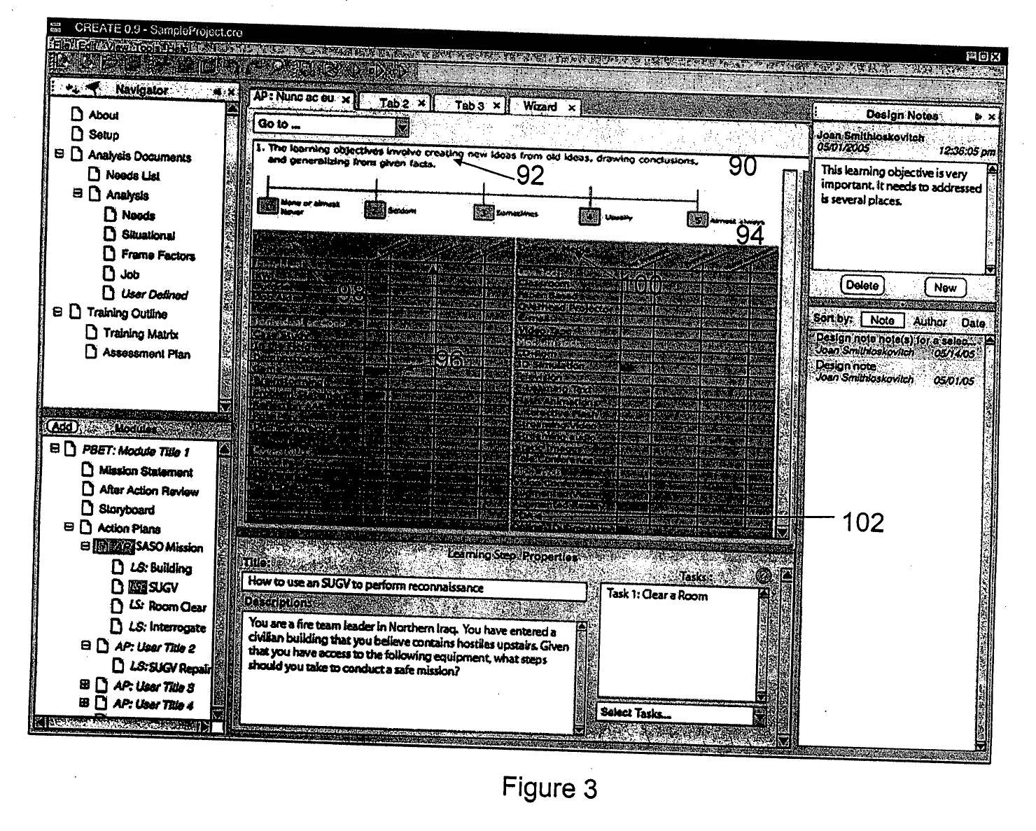

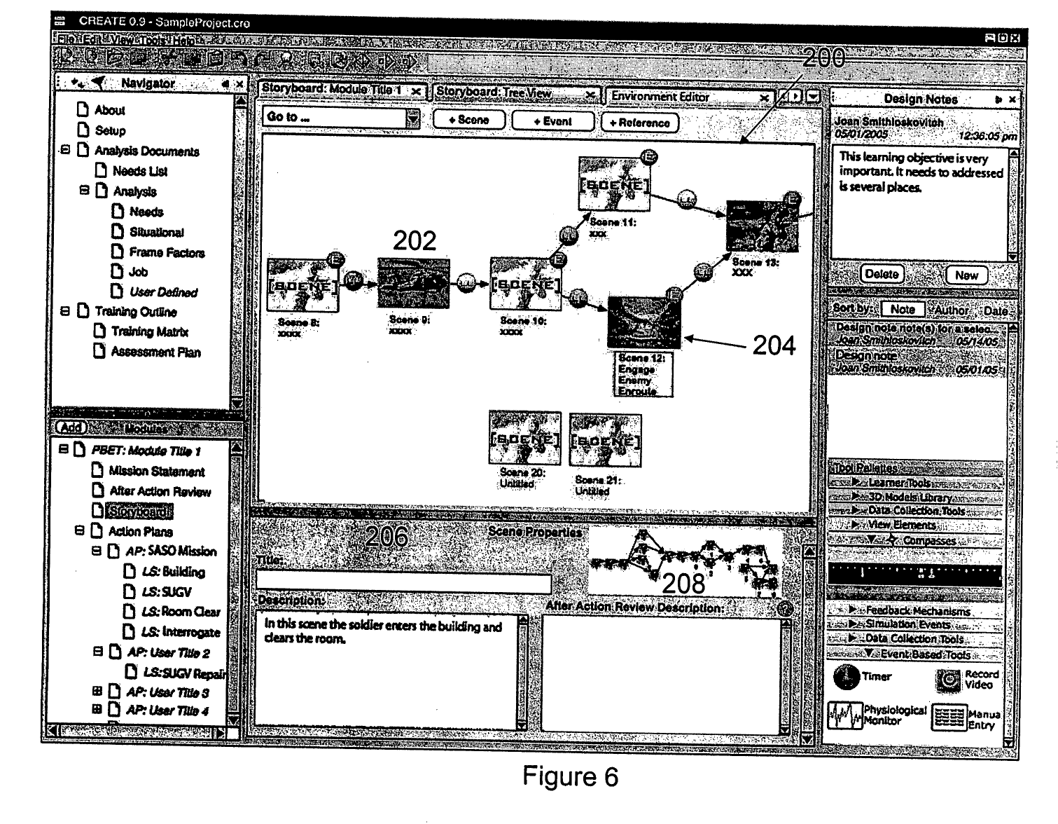

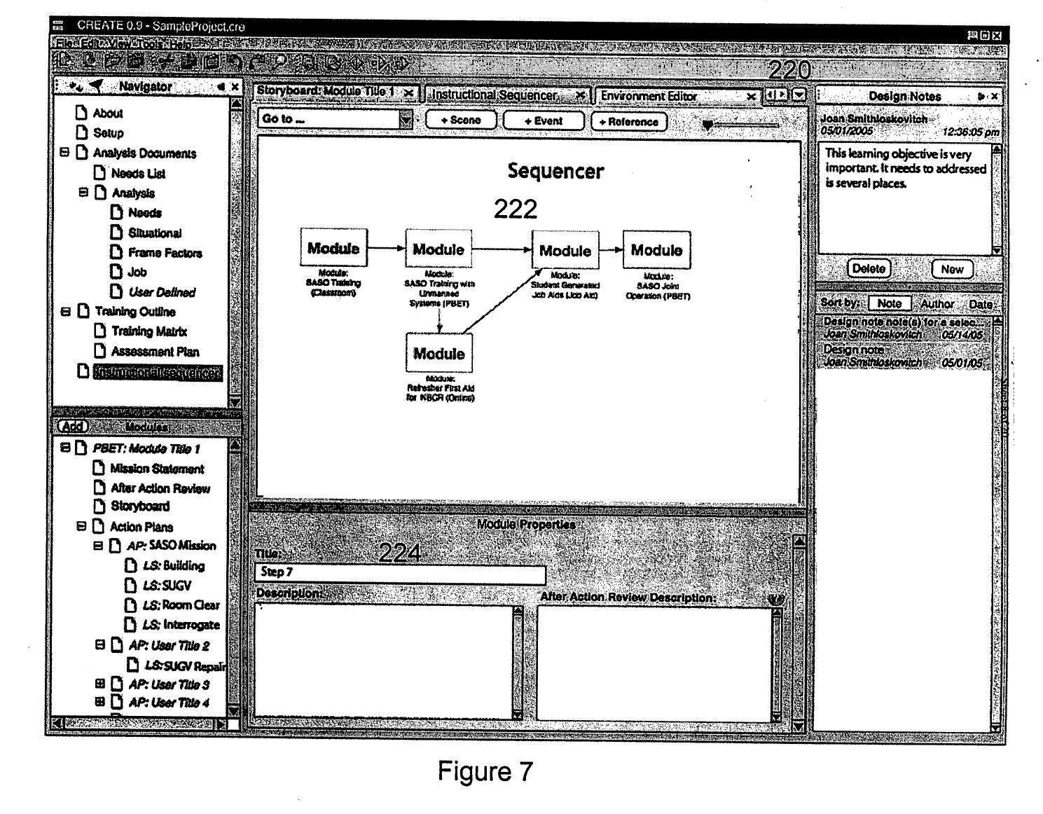

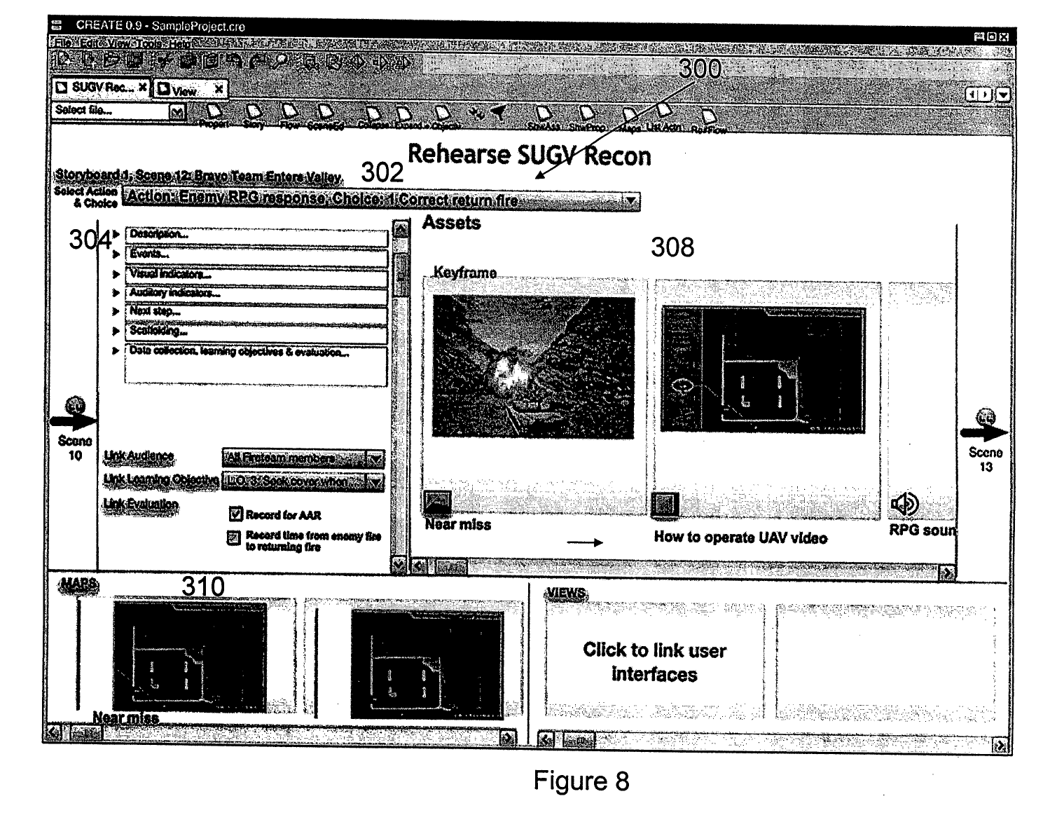

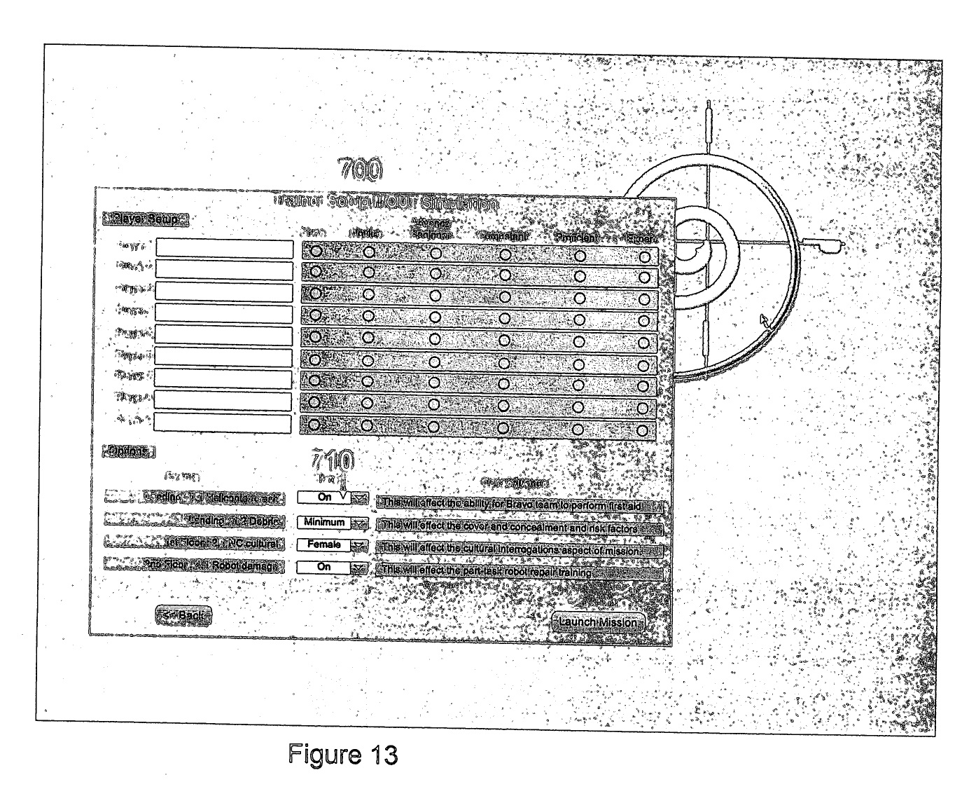

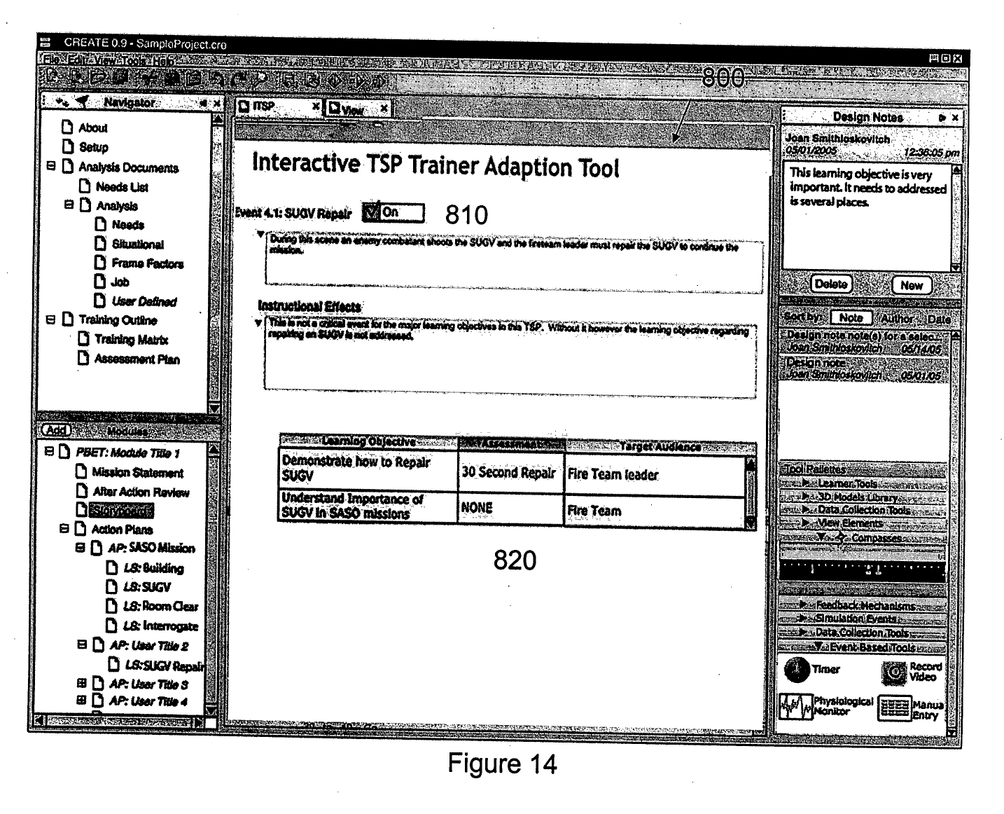

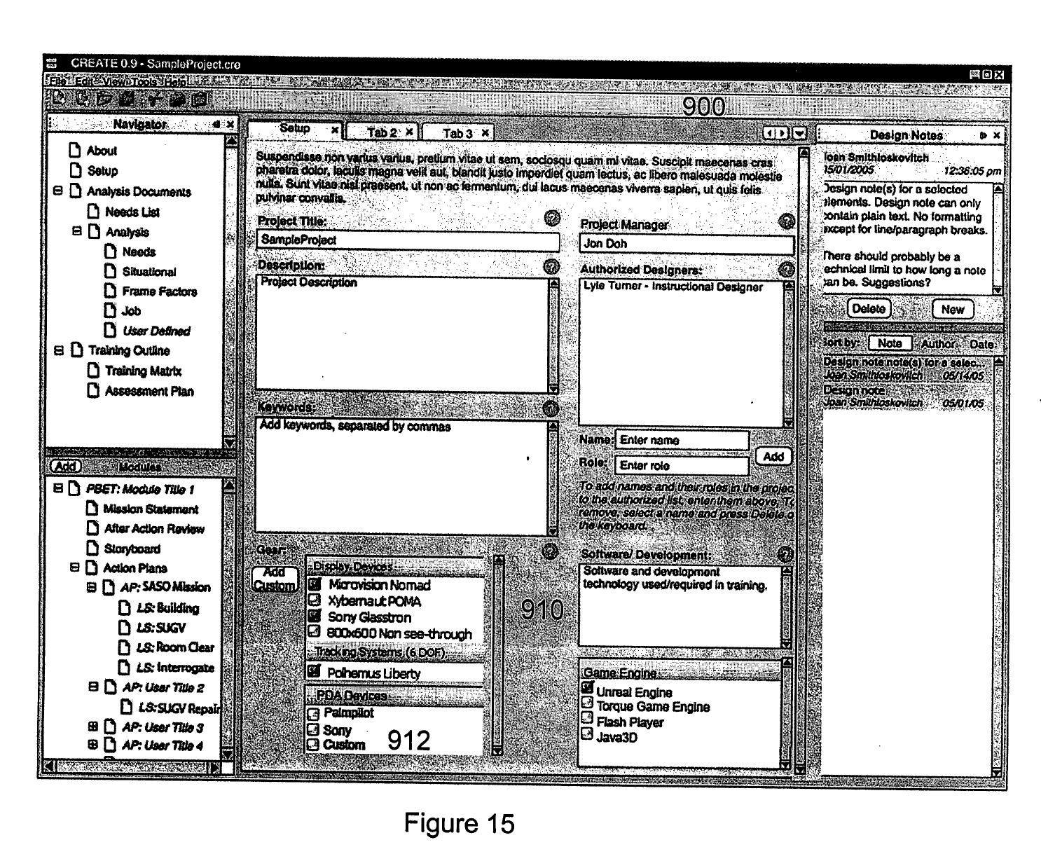

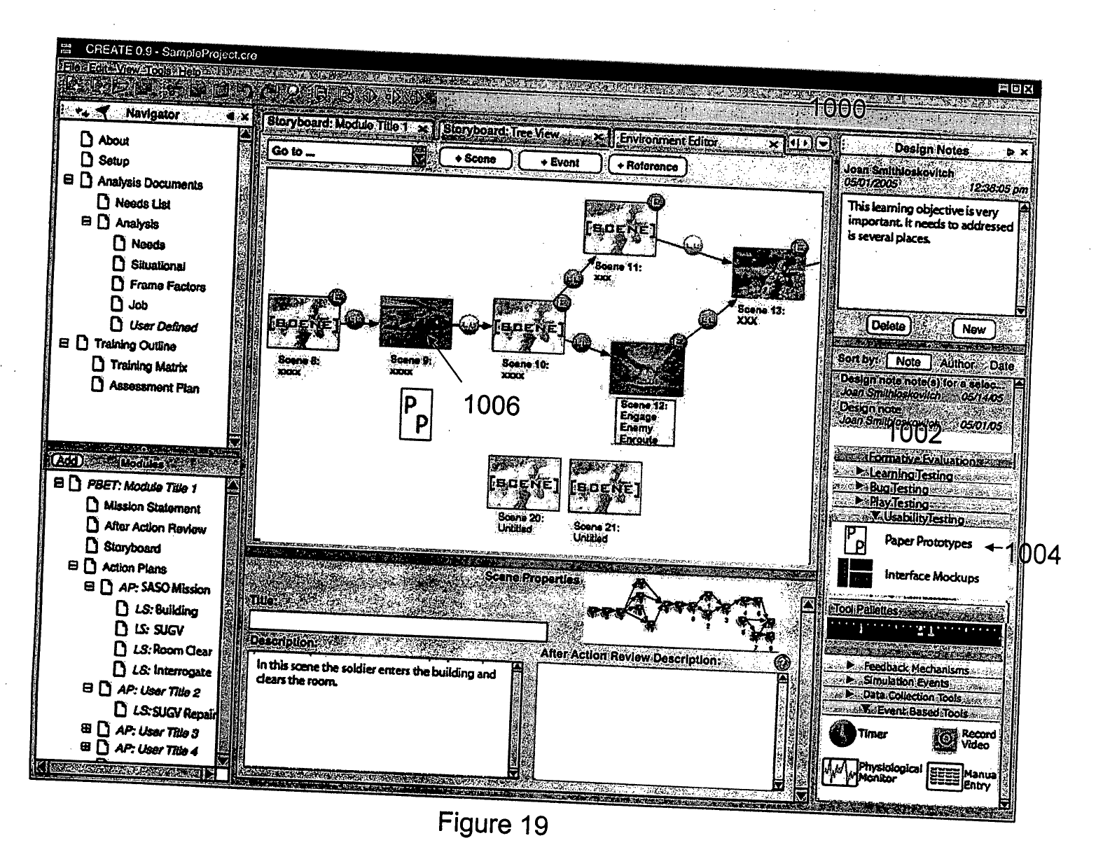

These three general phases may be examined by further breaking down the necessary steps into more specific phases. The analysis phase, as exemplified by FIG. 2 below, relates to providing a systematic identification of needs of the end user and important factors to consider in designing the end product, whether a mixed reality training environment or a video game. With the initial analysis partially or fully completed, the design phase may be broken down into a planning component for instructional planning, trainer guidelines, learner guidelines, lesson plans, learner evaluation design (exemplified by FIGS. 3-5; 11-12) and an implementation component which creates interfaces (exemplified by FIGS. 8-10), creates storyboards (exemplified by FIGS. 6-7), makes and assembles pieces and creates programs (exemplified by sample production tools 23 of FIG. 1A), creates evaluation and usability standards for testing learning effectiveness, and monitors the process for bug testing and quality control (FIG. 19). In addition, the system may have tools that facilitate workflow and decision making by capturing information from the user through tools such as the Setup Editor (FIG. 15) or dynamically capturing information from user actions and choices in the tool. Once a production version of the desired environment is created, the trainer and learner adaptation and use phase involves the modification of components that are being used in learning environment and the real-time control of and insertion into run-time environments (FIGS. 13-14).

In certain embodiments of the invention, authoring tool 12 facilitates the above-described phases of an application in a manner that is generally consistent with the ADDIE model for Instructional Systems Design (ISD) embedded in authoring tool 12. In general, ISD methodologies for developing training programs provide a systematic approach for the evaluation of the needs of the training subject(s), the design and production of the materials or content for the learning environment, and the evaluation of the effectiveness of the instruction in meeting the needs of the leaner(s). The ADDIE model is generic to many different ISD models, and includes the following steps upon which the acronym “ADDIE” is based: Analysis, Design, Development, Implementation, and Evaluation. As is described in further detail below with reference to the operation of authoring tool 12, each step of the ADDIE model generates at least one output that informs the subsequent step. The ADDIE model exemplifies the advantages of associating the design and analysis information in the application content so that system operators may make modifications with the original concerns in mind.

Though it could be used in a linear non-iterative manner, authoring tool 12 deviates from the basic, linear approach of the traditional ADDIE model by facilitating simultaneous development of certain aspects of the application using an iterative, rapid prototyping approach. In the basic linear approach to implementing the ADDIE model, changes to the application may be implemented at various stages, but the overall impact of the changes may not be apparent until the application is complete. Moreover, the strict, sequential nature of a classic ADDIE implementation may not adequately facilitate communications among the participants, which may result in inefficiency and errors. By employing an iterative, rapid prototyping variation of the ADDIE model, authoring tool 12 enables efficient development of an initial prototype that generally represents the final application, but which is further defined and refined by designers and developers with an understanding of capabilities and look of the final application. Additionally, by employing a common set of tools and a consistent language throughout implementation, authoring tool 12 may avoid the above-described communication difficulties and the associated inefficiencies. Authoring tool 12 is configured to keep participants in the design, production, and end user phases appraised of the changes implemented by other participants and the status of each participant's work. While multiple parties may participate in the development and modification of a particular application, associating the initial design and analysis information with the resulting application keeps all parties focused on the needs and goals of the application. Thus, authoring tool 12 functions as a teamwork workflow and management tool embodied within an authoring tool for applications.

An exemplary embodiment of authoring tool 12 is described herein for creating an application based on the Problem Based Embedded Training (PBET) training methodology. PBET is a method of training designed to ensure that trainees are competent in skills identified in a front-end analysis and described in measurable learning objectives. In general, the responsibilities of the trainee are examined to create a list of expected tasks in which the trainee must be competent. The task list is used to create a set of clearly worded learning objectives designed to ensure easy identification of a trainee's success in performing a task. The content of the training program (or application in the case of the present invention) is derived from the learning objectives. The content is designed to permit the trainee to practice a plurality of tasks related to equipment usage to develop the skills necessary to achieve competence in all identified areas. Typically, a trainee is required to master certain basic skills before advancing to other tasks in the training program, although such an approach is not necessary in all applications. However, due to the flexibility of authoring tool 12, other models of environment creation and maintenance may be used and implemented with other sets of design information associated with the assets, interfaces, and environments of a project.

Referring back to FIG. 1A, asset pool 14 may include a learning content management system and/or include other external resources such as public domain image files and the like. In one implementation of authoring tool 12, asset pool 14 includes a military database having three dimensional soldier models, soldier attributes files, and other prepared content files stored therein. As is further described below, during the design phase of an application, authoring tool 12 accesses asset pool 14 to determine the domain specific content available for the design. During the course of application development, one possible iterative step is to modify and/or enhance asset pool 14 to contain further relevant content that assists in achieving the stated needs and objectives of the application.

Tools for production 16, 25, may include any of a plurality of available mixed reality and/or video game engines such as (Unreal, Torque, mobile augmented reality systems, Mobile Augmented Reality Contextual Embedded Training and EPSS system, Designer's Augmented Reality Toolkit, ARToolkit, CREATE). Runtime environment 18 is used to examine the output of tools for development 16, 25 and includes the end user interface except those parts of the interface resident in the runtime environment. Optional learning management system 20 may be employed to control the overall learning environment (for training or learning applications). For example, learning management system 20 may include software that controls access of a user to advanced modules of a multi-step training program based on the user's ability to pass more basic modules in the program. Tools for design and runtime evaluation 22, 23 may include various software programs for modifying parameters and providing new inputs (images, sounds, etc.) to interfaces, setting up the recording of the activities in the environment and creating evaluation criteria to be monitored during end user interaction with the environment.

As another example, if the intended application is for use with a specific brand and model head-up display, analysis and planning editors and wizards 17, 24, 90 may suggest font sizes, colors, and other characteristics best suited for the particular head-up display. Alternatively, the characteristics of the desired head-up display may be entered without reference to a specific brand or model. If a particular piece of hardware or desired characteristics, for example, is not specified during the set-up process, authoring tool 12 is configured to suggest appropriate hardware options during or after the set-up process. In this manner, authoring tool 12 assists the operator in making intelligent design decisions based on parameters provided by the operator and/or informs the operator of the required resources for effective implementation of the application after the design set-up is complete. For example, authoring tool 12 may display an application as the application would appear on its intended hardware/software configuration, rather than the format achievable on the designer's equipment (which often does not have equivalent equipment as the end user). Authoring tool 12 may further include a set of tools (e.g., Setup Editor) that enables a user to enter information about a variety of issues that may include the following as well as other pertinent data: the end users (e.g., skills, aptitudes, attitudes, interests), end user environment (e.g., weather, lighting conditions, noise), equipment and tools available for production and runtime delivery, specific runtime environments to be used, specific production environments, specifications for desired functions of the runtime environment and/or specifications of desired functions in the production environment. From the various data entered into the system, the tool may perform a variety of tasks for the designer including: automatically adjusting the user interface of the CREATE environment (e.g., making certain tools visible and hide others that are not needed for the project; automatically searching the asset library to find items that might be useful in the project), customizing the assistance it provides to the designers/developers (e.g., provide tips about how to design game tasks for a specific game engine), making recommendations about interface design (e.g., screen layouts for a particular set of eyewear or font sizes for reading while moving), etc.

Referring now to FIG. 2, design entry screen 40 is depicted as generated by analysis and planning editors and wizards 17, 24 during the design phase of an application. As shown, design entry screen 40 generally includes main tool bar 42, project navigator window 44, working window 46, and design notes window 48, all presented in a format using the Sun open-source NetBeans development software. Main tool bar 42 includes a plurality of navigation buttons and general purpose tool icons, collectively designated reference numeral 41. In the description below, certain features are depicted in several screen views but not elaborated on in every or any description of the Figures. Such features may be present on multiple screens, and may be added to screens or other interfaces where appropriate, so the omission of one or more of such features in a particular embodiment does not exclude such features from appearing in other contexts.

Project navigator window 44 generally provides an outline of an application under development in a tree structure format. Project navigator window 44 includes tool bar 50 and application tree structure 52. Tool bar 50 includes, among other things, search icon 54 that generates a search field (not shown) that permits the operator to locate items associated with tree structure 52, filter icon 56 that generates a filter field (not shown) that permits the operator to project navigator window 44 to display only items that satisfy the filter field in tree structure 52. This feature may be used to pre-configure certain screens so that only the information and tools relevant to the creation of a particular type of environment are displayed.

Tree structure 52 is automatically populated with items as the application is being designed and developed. Tree structure 52 includes a hierarchal listing of expandable elements including top level headings such as set up documents 58, analysis documents 60, training outline 62, and instruction modules 70. Below each of top level headings 58, 60, 62, 70 are a plurality of lower level headings that relate to the associated top level heading 58, 60, 62, 64. For example, under training outline 62 are instructional sequence heading 66, module 1 name heading 68, and optionally other modules which may be immediately viewable or off the display but able to be viewed by scrolling through the box under the heading. Additionally, under the lower level headings are a plurality of sub-headings, each of which may include a plurality of sub-headings, each of which may include another plurality of sub-headings, and so on. Any of the above-described headings or sub-headings may be linked to a document or an external resource such as those resources associated with external asset pools 14. By selecting any of the headings of tree structure 52 (e.g., left-clicking on a mouse), the operator causes analysis and planning editors and wizards 17, 24 to populate working window 36 with items associated with the selected heading. Alternatively, the operator may add new headings anywhere in tree structure 52 by, for example, right-clicking a mouse and selecting “add.”

Working window 46 may include a plurality of tabs 72 that, when selected, provide different content 74 and toolbars 76 within working window 46 for performing specific tasks relating to the selected heading in tree structure 52. Content 74 of working window 46 may include a plurality of links 78 to documents and/or resources associated with the task selected using one of tabs 72. Each of links 78 may include text field 80 into which the operator may type a description or comment to be associated with the link 78. When content 74 of working window 46 is modified or added, the operator may select upload icon 36 in toolbar 76 to cause analysis and planning editors and wizards 17, 24 to populate database 14.

Design notes window 48 generally includes toolbar 82, notes list area 84, and notes content area 86. Toolbar 82 includes icons that permit the operator to search, sort, filter, etc. items displayed in notes list area 84. Notes list area 84 includes dated entries 88 of notes corresponding to content 74 of working window 46. When the operator selects any of entries 88, the content of all notes corresponding to the selected entry 88 is displayed in notes content area 86. These notes may be permanent notes to be provided, for example, to the end user upon completion of the application, or temporary notes for use by participants in the design and development of the application which are deleted after the application is complete.

FIG. 3 illustrates an example of a wizard assistant used during the design and analysis phase of the application. As shown, wizard window 90 may be displayed on interface 40 in working window 36 upon selection of wizard tab 72. Design notes window 48 has been collapsed. Wizard window 90 of FIG. 3 would generally be available during the design of the items associated with training outline heading 62. However, a plurality of context sensitive wizards may be available at various locations of tree structure 52. Wizard window 90 generally includes question area 92, answer area 94, (as well as other mechanisms such as checklists) and recommendation region 96. Question area 92 displays questions designed to assist the operator in designing the aspect of the application associated with the current content of working window 46. The questions may be designed to elicit answers that describe a characteristic or attribute of the application in terms of its frequency, importance, and/or other relevant characteristics. Options for responses to the questions displayed in question area 92 are displayed in answer area 94.

In the example shown, the response options relate to frequency on a scale from “none or almost never” to “almost always.” The questions presented in question area 92 are designed to elicit answers that inform decisions about design of the application, including, for example, instructional strategies for applications having an instructional or learning component, and delivery media as illustrated in recommendation region 96. Recommendation region 96 includes instructional strategy portion 98 and delivery media portion 100. Instructional strategy portion 98 includes a plurality of different instructional techniques. Techniques that are designed for individual instruction are grouped together, as are techniques designed for either individual or group instruction and techniques designed for group instruction. A recommendation rating is associated with each technique, and ranges from “not recommended” to “highly recommended.” Similarly, delivery media portion 100 includes a listing of delivery media that are grouped by their technology level (low tech to high tech). Each delivery media has an associated recommendation rating ranging from “not recommended” to “highly recommended.” As the operator answers questions presented in question area 92, analysis and planning editors and wizards 17, 24 adjusts the recommended rating of appropriate instructional techniques and delivery media such that wizard window 90 simultaneously provides a plurality of rated options for attributes of characteristics of the application.

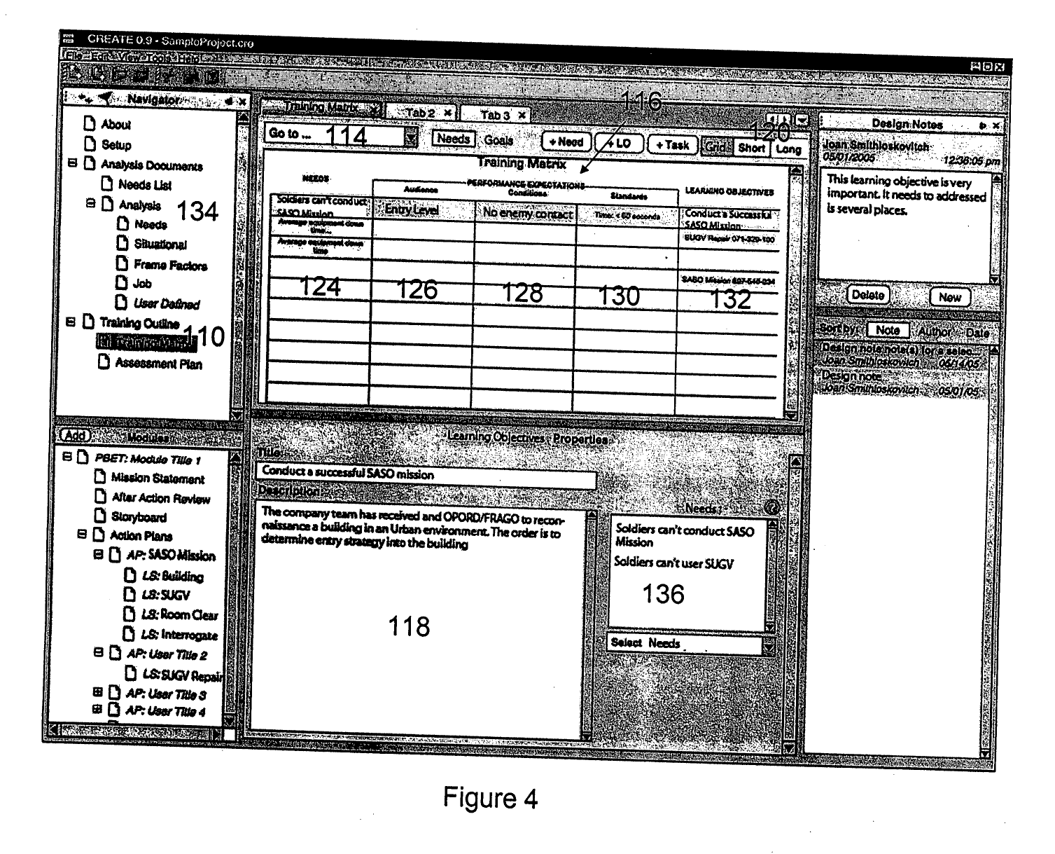

In the example of the present explanation, the above-described analysis portion of the design phase may be followed by a detailed definition of components of the training that will achieve the needs identified in the analysis portion. As shown in FIG. 4, when the training matrix sub-heading 110 of tree structure 52 is selected, training matrix window 112 is displayed in working window 46 of design notes window 48. The Training Matrix view in FIG. 4 is the grid view as opposed to the outline view 300. Training matrix window 112 generally includes toolbar 114, matrix area 116, and detailed view area 118. Toolbar 114 includes table icon 120, selection of which causes the information in matrix area 116 to be displayed in a tabular format as shown in the figure, and tree icon 122, selection of which causes the information in matrix area 116 to be displayed in a tree structure format such as that of tree structure 52. Matrix area 116 includes needs column 124, audience column 126, conditions column 128, standards column 130, and learning objectives column 132, as well as other user selected information. In this example, an instructional designer may be responsible for filling out matrix area 116. Needs column 124 includes a listing of needs identified during the analysis portion of the design phase, which are also associated with the list of needs sub-heading 134 of tree structure 52. For example, one need may be to maintain certain equipment in operational condition at all times. Learning objectives are associated with needs through a menu 136. Needs can have a plurality of learning objectives.

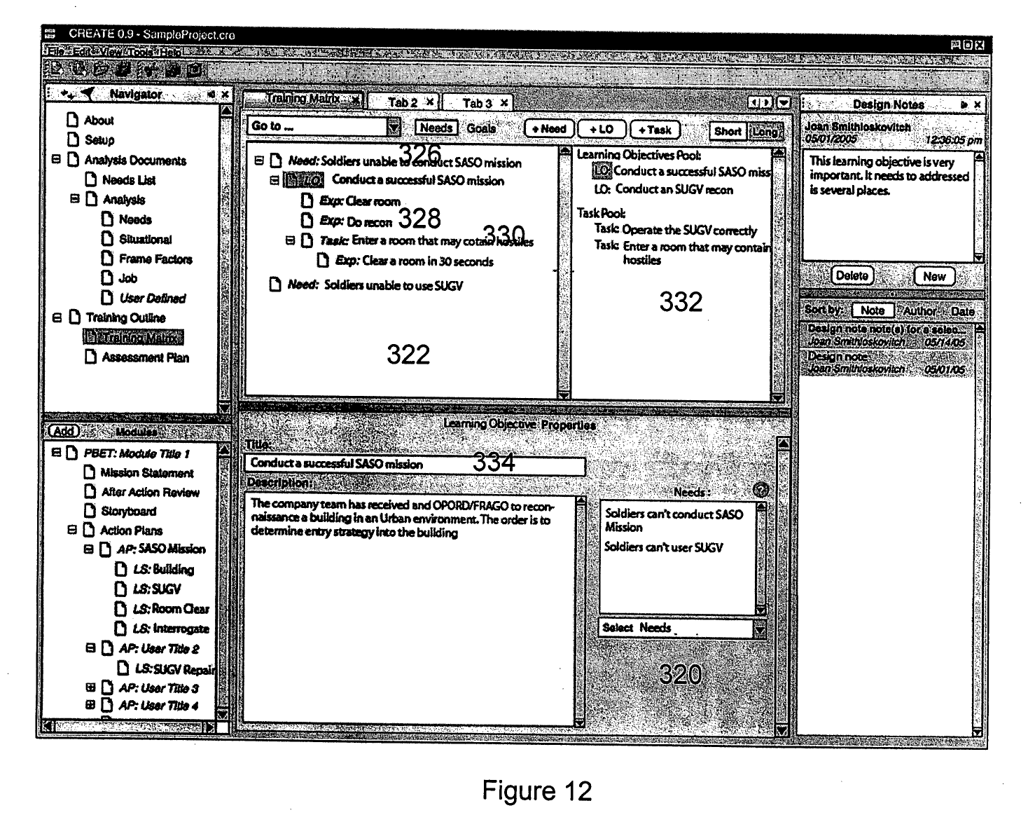

In FIG. 12 the outline view of the training matrix 322 presents the same content that the grid view but in an outline form 324. Needs 326, learning objectives 328, and tasks 330 are created in the pool area 332 and then assigned to the project in the outline area 322. Properties of the selected item are displayed in 334. Needs are assigned to learning objectives in 320.

Referring back to FIG. 4, audience column 126 includes an identification of the target audience associated with each need. In the illustrated example, the target audience for each of the listed needs is described as “Entry level infantryman.” Conditions column 128 includes entries describing the conditions (e.g., night operations without enemy contact) under which each need will be assessed. Standards column 130 includes entries describing the requirements (e.g., time restrictions) for performing the corresponding learning objective associated with the listed need. Learning objective column 132 includes entries describing a particular task that will be implemented by the application to train the audience to satisfy the need. For example, a need may be defined as using proper cover and concealment techniques in all situations. Corresponding learning objectives may be to stay covered and concealed in a cluttered urban environment, to stay covered and concealed in the dark, and to stay covered and concealed in the dark using infrared goggles. The learning objective entries are customized to a particular instructional situation (e.g., a classroom setting, a video game, an MR application, etc.).

Each need may be repeated in matrix area 116 for association with different audiences, conditions, standards, and learning objectives. By selecting a particular need (e.g., with a mouse click), the operator causes detailed view area 118 to be populated with expanded information (if it exists) corresponding to the entries in each of columns 124, 126, 128, 130, 132 corresponding to the selected need. Any of the entries may be edited in detailed view area 118. Additionally, the operator may select a blank need entry to obtain blank fields in detailed view area 118. In this manner, the operator may define new rows in matrix area 116.

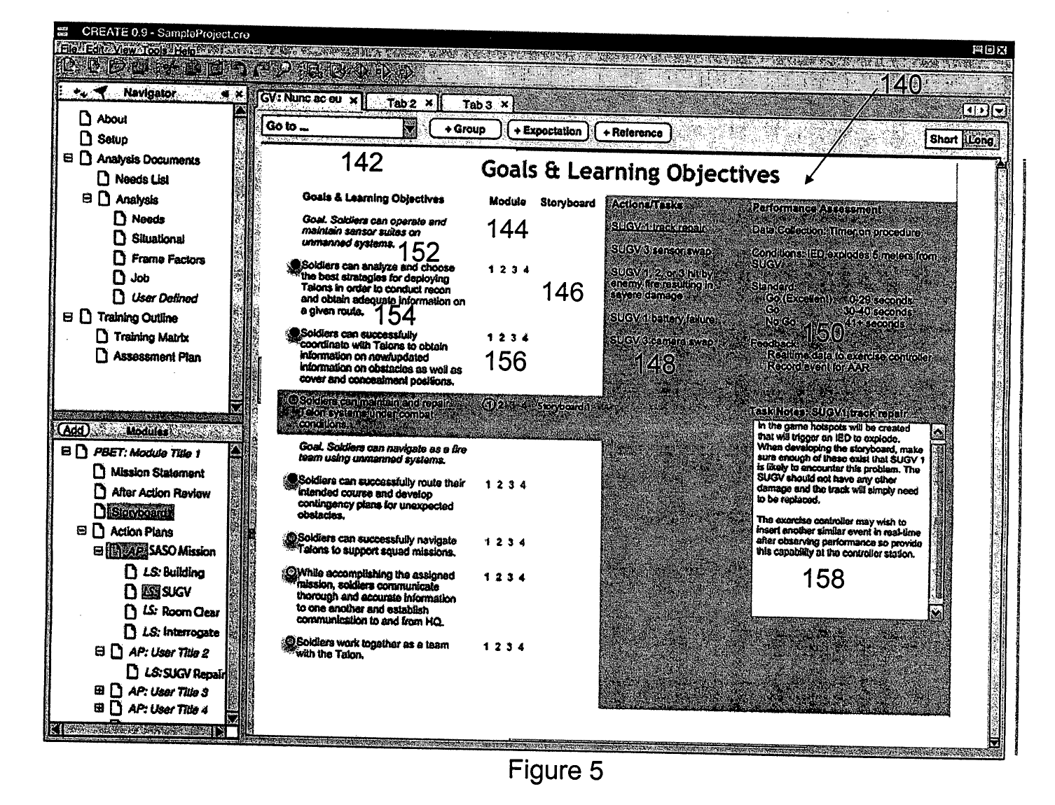

FIG. 5 depicts an overview window 140 in working window 36 that may be accessed by activating an action plan in modules 70 from any of the foregoing screens. Again, design notes window 38 has been collapsed. Overview window 140 generally includes goals and learning objectives column 142, module column 144, storyboard column 146, actions/tasks column 148, and performance assessment column 150. Goals and learning objectives column 142 includes a plurality of goal statements 152, each having one or more learning objectives 154 listed below. Each learning objective has completion button 156 that permits the operator to indicate (e.g., by toggling through red, yellow, and green colors) the extent to which the application as thus far designed addresses the associated learning objective or goal. Module column 144 includes, for each learning objective 154 in goals and learning objectives column 142, a listing of module numbers 156 that corresponds to module subheadings 68, 70 of tree structure 52. Each module number 156 listed in module column 144 is presented in bold font if the learning objective 154 associated with the module number is addressed in the module. As indicated by the gray highlighted portion of overview window 140, when one of learning objectives 154 is selected, module numbers 156 associated with the selected learning objective 154 are highlighted, and storyboard column 146, actions/tasks column 148 and performance assessment column 150 are populated with information relating to the first module number 156 associated with the selected learning objective 154. Other module numbers 156 may be selected to automatically populate columns 146, 148, 150 with information related to the selected module number 156.

In the illustrated example, the highlighted storyboard entry in storyboard column 146 indicates that a storyboard has not yet been created for module number 1 of the selected learning objective 154. The association with a storyboard can later be made. Actions/tasks column 148 lists a plurality of tasks that have been identified as appropriate for accomplishing the selected learning objective 154. When a task in actions/tasks column 148 is selected (as indicated by the underlined task “SUGV 1 track repair”), performance assessment column 150 is populated with information related to the selected task. In this example, the time occurrence of the task in a video game is indicated, the conditions under which the task will be performed are described, the standards for evaluating the trainee's performance are listed, the method for reporting the trainee's performance is described, and notes relating to the task are displayed in notes window 158. The operator may simply select any of the items listed in performance assessment column 150 to change the associated attribute(s).

Much of the information displayed via overview window 140 is also displayed in training matrix window 112 of FIG. 4. In overview window 140, however, the focus is on the relationship between learning objectives and goals and how these relate to the learner activities (in this case a training game) 148 and assessment 150. As shown, learning objectives 154 are grouped as they relate to listed goal statement 152. The overall presentation of information in overview window 140 provides the operator with an understanding of the manner in which substantially all items in an application relate to one another, even before the application is fully designed. This overview information may be provided to a developer who can build individual items with an understanding of the overall structure of the application. Conversely, pre-defined or already completed items (e.g., particular cityscapes, terrains, equipment models, etc.) can be linked via overview window 140 into the instructional design phase. Authoring tool 12 thus allows the development of the mixed reality presentation, in this exemplary embodiment being a training application, to be iterative in nature. Such iterative development allows the developers to leave items undefined as the application is being built, and later re-visited as the project is iteratively designed. For example, a standard entry in performance assessment column 150 may be left undefined until the application is complete. In the case of a video game application, the developer may perform the associated task in runtime environment 18 several times to determine the appropriate standard, and define the standard at that time. Alternatively, a standard may be defined long before a delivery media is developed to perform the associated task. Such examples demonstrate the non-linear characteristics of authoring tool 12 which deviate from a strict ADDIE approach. In addition, as these items are used in other parts of the design, such as a task 148 added in the storyboard editor to a storyboard, that information is automatically reflected here.

FIG. 6 shows storyboard panel 200 created by a system designer in conjunction with a training plan created with the above mentioned design and analysis components of the invention. In this section, specific audio and visual environments may be specified, either from a physical observation, a computer model generated environment, or a combination of the two. In addition, intelligent software agents may be provided to automatically adjust content and interface elements so that it is optimized for specific display characteristics. This may take into account not only the display characteristics but environmental conditions (e.g., brightness of ambient light; noise), user characteristics (e.g., color blindness; reading level; human visual field of view; peripheral vision limits; known abilities of humans to process multiple channels of information) and task needs (e.g., end user is walking so he needs less information on the screen at a time; voice control is better than mouse control for a particular task characteristic). The storyboard display 202 may also be used to invoke a preview mode that presents the environment to the developer as the end user would sense the environment, along with the effects that the particular hardware may impose on the end user. In addition, intelligent agents may use data collector tools (e.g., timers, mouse tracking) to elements in an interface, including both automatic data collectors and manual entry by the developer observing the environment. This may also include synchronized data from external sources such as video recordings of subject actions, environmental conditions and other contextual data. An artificial intelligence engine may fuse together the various data sources and present information to the developer in a usable format, that engine being programmed to recognize patterns that would be difficult for a human developer to identify because of the substantial amount of data that may be present in an environment. The artificial intelligence engine may also take into account test subject characteristics that are relevant to the interface under development (e.g., color blindness, age, reading ability). The developer may specify the information to be presented to the artificial intelligence engine to focus that analysis.

Storyboard display 202 provides a view of one or more connected scenes involved in the module being displayed. When a particular scene 204 is selected by the user, then scene properties section 206 provides details about that scene. Overview section 208 provides a high level view of the entire storyboard on storyboard display 202 (because a storyboard may be created that is larger than display 202). Through interaction with scene properties 206, the system designer may monitor the status of end users in that scene, and possibly modify the environment associated with the scene to optimize performance or evaluation criteria.

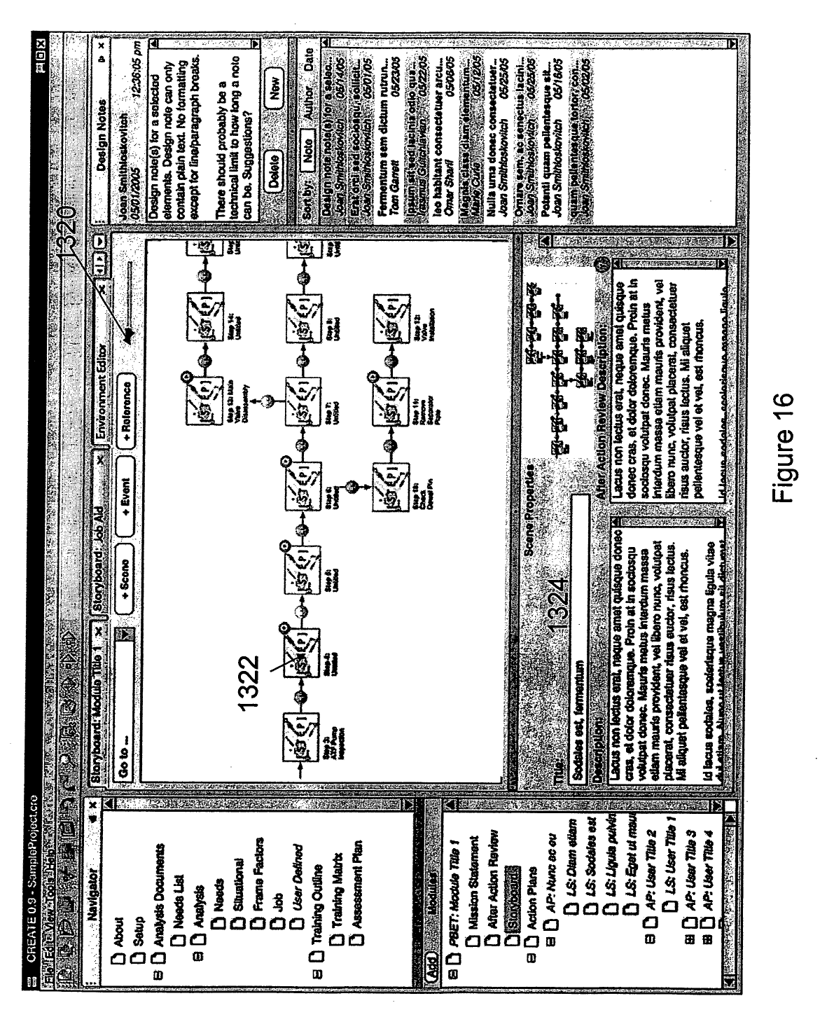

FIG. 16 shows an entire project, a series of storyboards created to train, test, or simulate a particular action or procedure. Project display 1300 shows the interconnection of modules 1302, where the activation of one of modules 1302 activates a corresponding step properties detail 1304. This allows a system designer to modify a parameter in an entire module by the various storyboards inheriting the common characteristic provided at this level.

FIG. 8 shows scene implementation screen 300. Screen 300 provides the system designer with the ability to associate particular assets with design information relating to that scene. In the depicted screen, Select Action 302 may include one or several actions, with comments section 304 providing information on the design objectives of the selected action. Comments section 304 may also have further specification of the mixed reality or video game environment, for example, allowing specification of other end users who may be linked with the subject end user, specifying the learning objective, or specify evaluation criteria. Asset section 308 allows selection and association of one or more component assets in a particular selection action. In the depicted example, a SUGV Recon scenario is associated with at least an image, a model map, and/or a sound button with the selected action. Further details regarding this scenario are provided in map section 310 depicting the maps and models for the selected scene, while view section 312 shows the view from the interface (i.e., the end user's perspective).

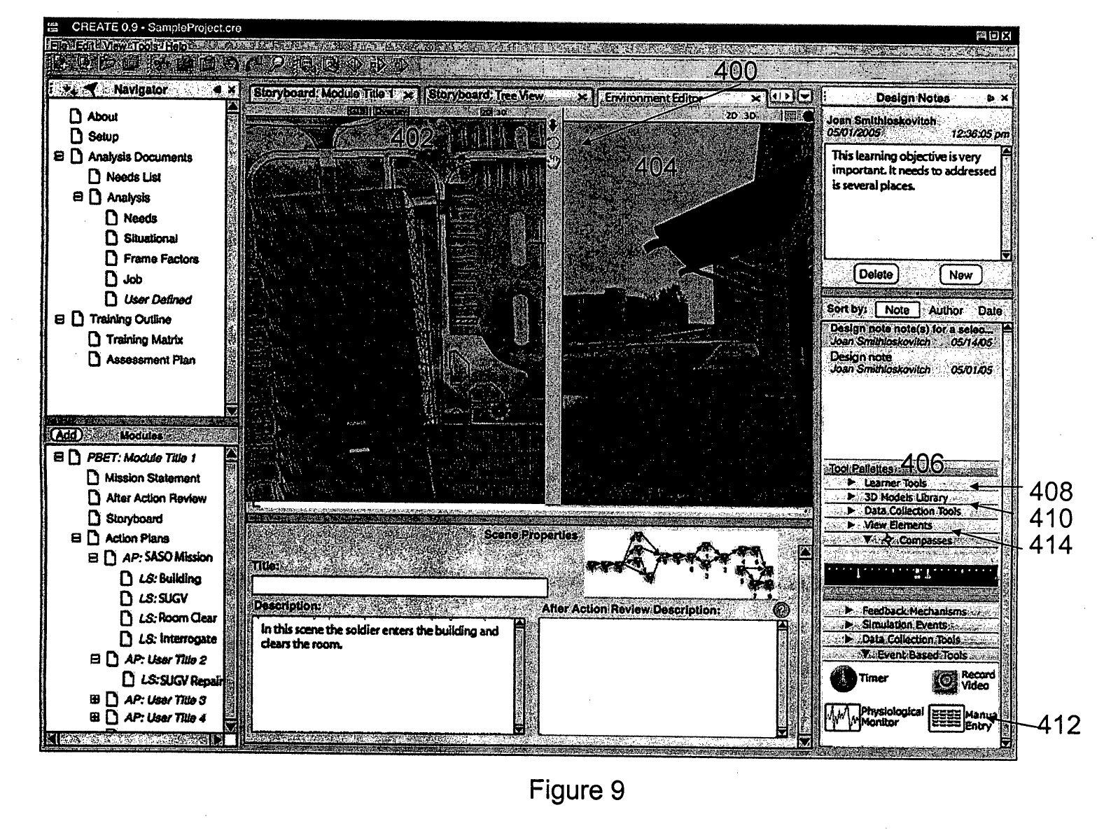

FIG. 9 shows environment editor screen 400. Multiple views of a scene for the developer are provided by top plan perspective window 402 and 3D perspective window 404, and other views may also be provided. In addition to providing the views of a subject scene, palettes menu 406 provides additions and/or overlays for the depicted scene. For example, palettes menu 406 has tools submenu 408 which may be activated to provide a menu of additional image, sound, or other items to add to a scene. 3D models submenu 410 may also be activated to provide additional models for supplementing and/or replacing one or all components of the subject scene. Data collection submenu 412 provides the developer with options for recording and evaluating performance in the mixed reality environment of the subject scene. View elements submenu 414 may provide additional features for the developer, e.g., a compass function to indicate direction in one or more of the views of the subject scene. Tools submenu 408, when activated, provides an additional array of assets for incorporation into the subject scene, including learner tools (e.g., tools to manipulate data, diaries for metacognitive reflection, tools to display job aids), feedback mechanisms (.g., common items that might be added to a game like an enemy ambush sequence previously developed for another game), simulation events (e.g., onscreen notification of performance, automatic recording of data for later review), and data collection tools (such as a timer, video recorder of the mixed reality images, physical monitor of the end user, or manual entry for observer notes).

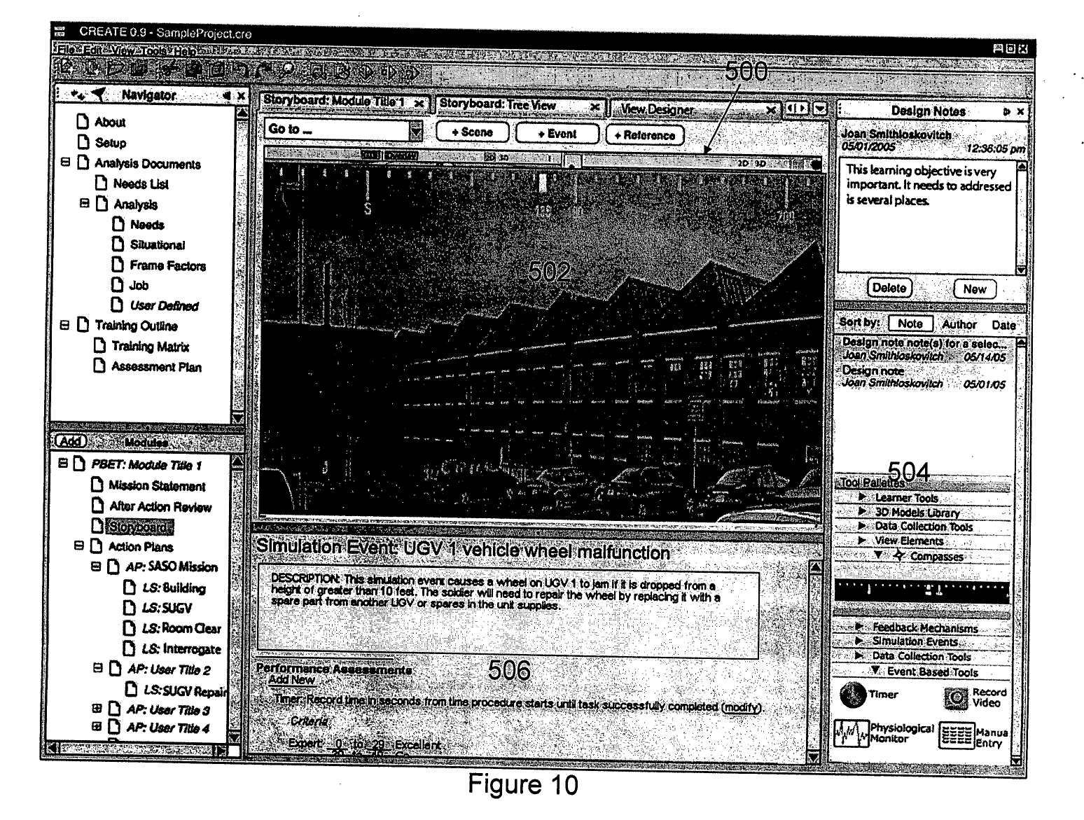

FIG. 10 shows view designer screen 500. View designer window 502 provides an image corresponding to the subject scene, possibly in one or more of the perspectives provided by environment editor screen 400 of FIG. 9. Palettes menu 504 is similar to its corresponding menu in FIG. 9, but with different options for the purposes of view designer screen 500. Cross-referencing many of the design parameters, properties editor 506 provides the designer with the ability to view the subject scene in light of the goals and learning objectives from FIG. 5.

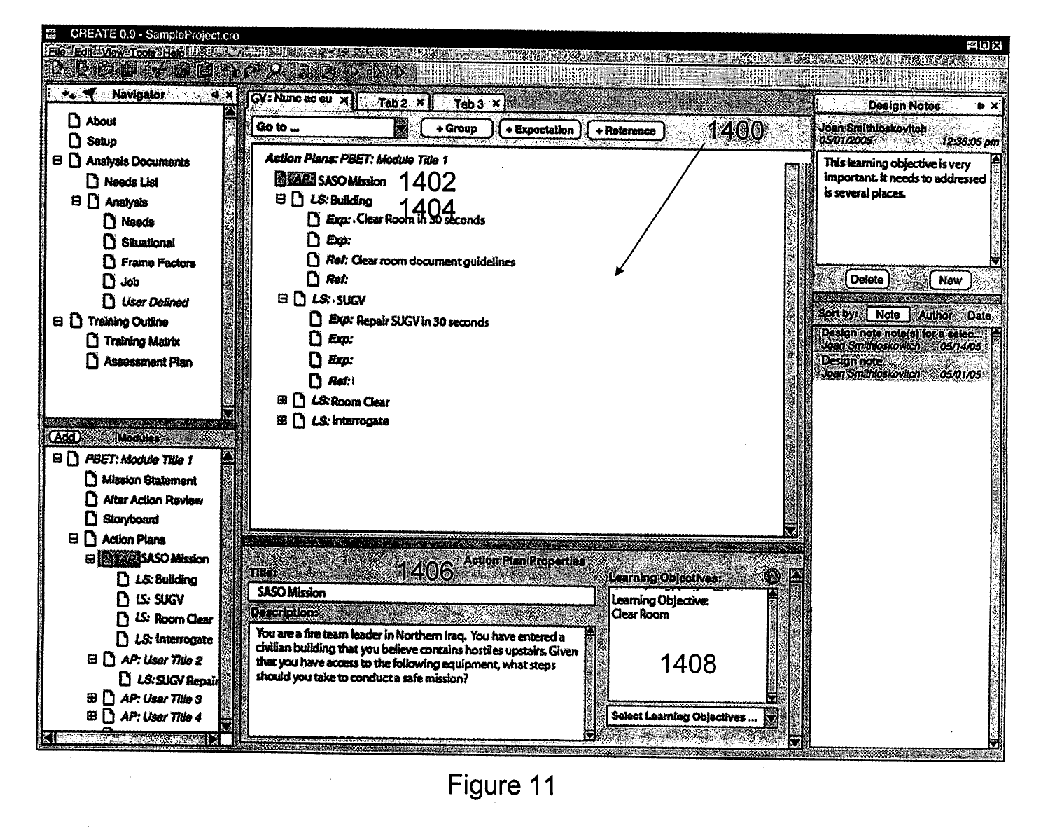

FIG. 11 Depicts an Action Plan tab 1400. The action plan outline displays all the learning activities in that particular category 1402. The Learning Step is one learning activity included in the action plan grouping 1404. Action Plan Properties 1406 determine what learning objectives are associated with that action plan 1408.

In FIG. 12 The outline view of the training matrix 322 presents the same content that the grid view but in an outline form 324. Needs 326, learning objectives 328, and tasks 330 are created in the pool area 332 and then assigned to the project in the outline area 322. Properties are displayed in 334. Needs are assigned to learning objectives in 320.

FIG. 13 shows the trainer adaptation tool 700 which allows the trainer to adjust the training product before and during the training. The trainer 710 can, for instance, turn on events and modify certain predefined elements or configurations within the training product.

FIG. 14 shows the trainer adaptation tool creation screen. 800 This allows the user to define which elements are options for the trainer to manipulate during and before the training event. It also defines what type of learning objectives, assessment and audience intended for that particular event 820

FIG. 15 The Setup Screen defines many production and design elements used in other aspects of the software. In this example we have identified that no PDA devices will be used in this project. Due to this decision, in FIG. 4102 the Wizard will not provide information about PDA devices.

FIG. 16 depicts another use of the storyboard tool 1320. In this instance, a sequence of events is organized to make a job aid 1322. 1324 displays the properties for that particular step.

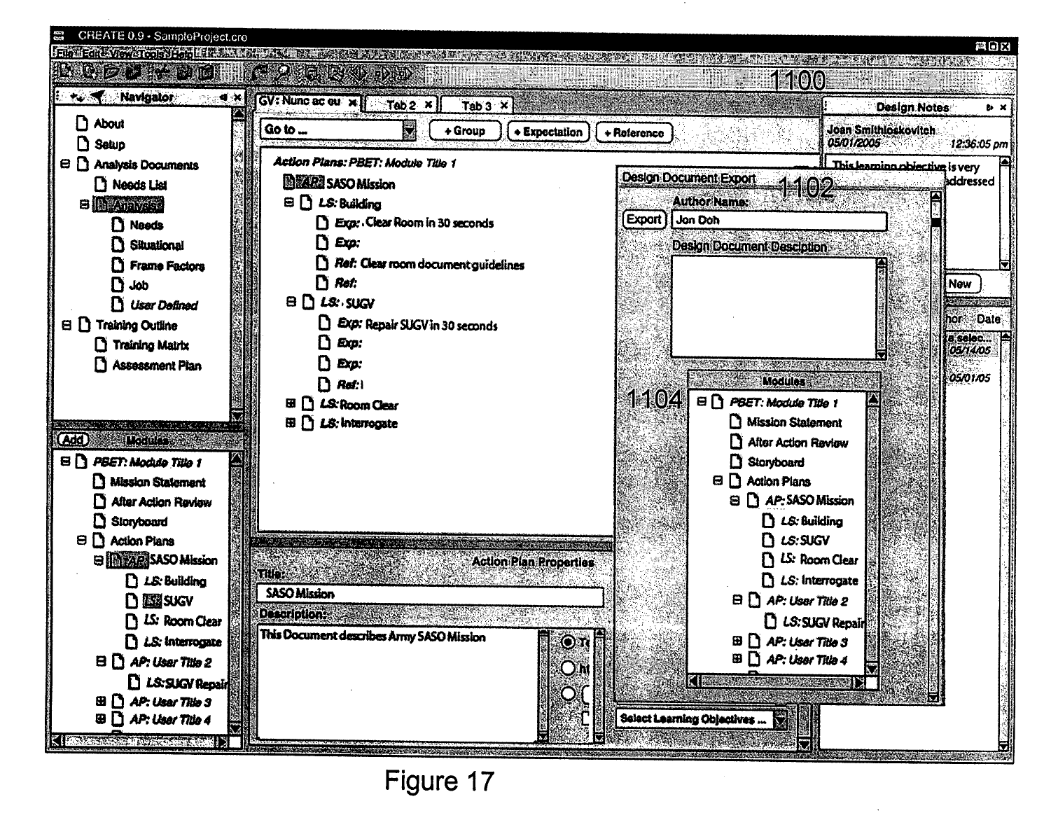

FIG. 17 Design Document Export 1100. Aspects within CREATE specific to the design of the learning environment can be exported 1102. Only elements that are relevant to the learning environment are included 1104. Notice these learning specific elements are defined throughout the CREATE Software and then aggregated in the export.

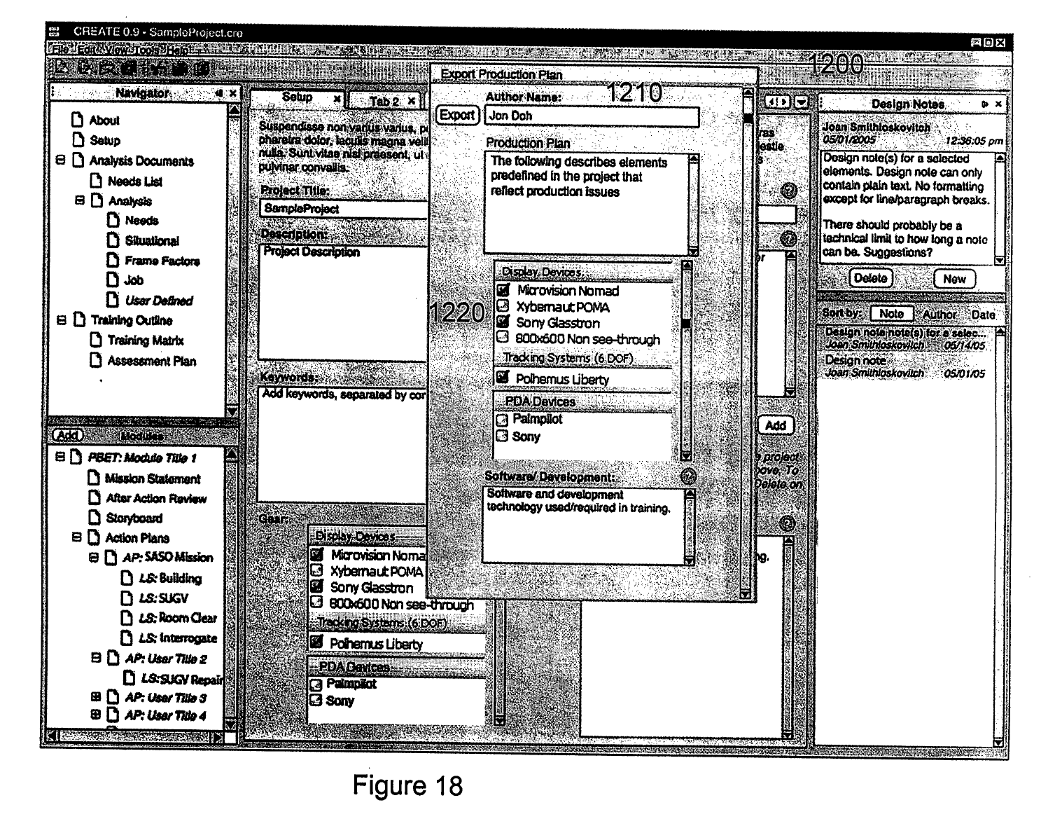

FIG. 18 Production Plan Export 1200. Aspects within CREATE specific to the production of the project can be exported 1210. Only elements that are relevant to the learning environment are included 1220. Notice these production elements are defined throughout the CREATE Software and then aggregated in the export.

FIG. 19 Formative Evaluation 1000. Formative Evaluation events 1002 can be added to elements within CREATE. Several evaluation types are available to the user 1004. Several evaluation events can be added to one or all stages in CREATE design tabs 1006.

The appendix contains an implementation of the present invention. The source code files in the appendix are associated with various directories to build an examplary application from the ARI-CREATESource directory using the build.xml file, as one of skill in this art would easily recognize, and such build libraries are incorporated by reference herein. A programmer with routine skill may create an executable program in keeping with the present invention from the source files in the appendix.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

Appendix B

[Note on the following pages, the root directory of the compact discs appears as “C:\BACKUP\”]

File: C:\ARI-CREATE Source\filelisting.txt 10/23/2005, 6:55:31PM

C:\ARI-CREATE Source\branding
C:\ARI-CREATE Source\build_xml.txt
C:\ARI-CREATE Source\create
C:\ARI-CREATE Source\filelisting.txt
C:\ARI-CREATE Source\branding\build_xml.txt
C:\ARI-CREATE Source\branding\core
C:\ARI-CREATE Source\branding\core-windows
C:\ARI-CREATE Source\branding\manifest_mf.txt
C:\ARI-CREATE Source\branding\nbproject
C:\ARI-CREATE Source\branding\src
C:\ARI-CREATE Source\branding\test
C:\ARI-CREATE Source\branding\core\org
C:\ARI-CREATE Source\branding\core\org\netbeans
C:\ARI-CREATE Source\branding\core\org\netbeans\core
C:\ARI-CREATE Source\branding\core\org\netbeans\core\startup
C:\ARI-CREATE
Source\branding\core\org\netbeans\core\startup\Bundle_create_properties.txt
C:\ARI-CREATE Source\branding\core-windows\org
C:\ARI-CREATE Source\branding\core-windows\org\netbeans
C:\ARI-CREATE Source\branding\core-windows\org\netbeans\core
C:\ARI-CREATE Source\branding\core-windows\org\netbeans\core\windows
C:\ARI-CREATE Source\branding\core-windows\org\netbeans\core\windows\view
C:\ARI-CREATE Source\branding\core-windows\org\netbeans\core\windows\view\ui
C:\ARI-CREATE
Source\branding\core-windows\org\netbeans\core\windows\view\ui\Bundle_create_properties
.txt
C:\ARI-CREATE Source\branding\nbproject\build-impl_xml.txt
C:\ARI-CREATE Source\branding\nbproject\genfiles_properties.txt
C:\ARI-CREATE Source\branding\nbproject\private
C:\ARI-CREATE Source\branding\nbproject\project_properties.txt
C:\ARI-CREATE Source\branding\nbproject\project_xml.txt
C:\ARI-CREATE Source\branding\nbproject\suite_properties.txt
C:\ARI-CREATE Source\branding\nbproject\private\private_properties.txt
C:\ARI-CREATE Source\branding\nbproject\private\private_xml.txt
C:\ARI-CREATE Source\branding\src\com
C:\ARI-CREATE Source\branding\src\com\iipi
C:\ARI-CREATE Source\branding\src\com\iipi\create
C:\ARI-CREATE Source\branding\src\com\iipi\create\branding
C:\ARI-CREATE
Source\branding\src\com\iipi\create\branding\Bundle_properties.txt
C:\ARI-CREATE Source\branding\src\com\iipi\create\branding\layer_xml.txt
C:\ARI-CREATE Source\branding\test\unit
C:\ARI-CREATE Source\branding\test\unit\src
C:\ARI-CREATE Source\create\build_xml.txt
C:\ARI-CREATE Source\create\lib
C:\ARI-CREATE Source\create\manifest_mf.txt
C:\ARI-CREATE Source\create\nbproject
C:\ARI-CREATE Source\create\src
C:\ARI-CREATE Source\create\test
C:\ARI-CREATE Source\create\lib\binding-1.0.jar
C:\ARI-CREATE Source\create\lib\forms-1.0.5.jar
C:\ARI-CREATE Source\create\nbproject\build-impl_xml.txt
C:\ARI-CREATE Source\create\nbproject\genfiles_properties.txt
C:\ARI-CREATE Source\create\nbproject\private
C:\ARI-CREATE Source\create\nbproject\project_properties.txt
C:\ARI-CREATE Source\create\nbproject\project_xml.txt
C:\ARI-CREATE Source\create\nbproject\suite_properties.txt
C:\ARI-CREATE Source\create\nbproject\private\private_properties.txt
C:\ARI-CREATE Source\create\nbproject\private\private_xml.txt
C:\ARI-CREATE Source\create\src\com
C:\ARI-CREATE Source\create\src\com\iipi
C:\ARI-CREATE Source\create\src\com\iipi\create
C:\ARI-CREATE Source\create\src\com\iipi\create\BeanProvider_java.txt
C:\ARI-CREATE Source\create\src\com\iipi\create\Bundle_properties.txt
C:\ARI-CREATE
Source\create\src\com\iipi\create\ConstrainedIndexedPropertyList_java.txt
C:\ARI-CREATE
Source\create\src\com\iipi\create\CoupledIndexedPropertyList_java.txt
C:\ARI-CREATE Source\create\src\com\iipi\create\createprojects_settings.txt
C:\ARI-CREATE Source\create\src\com\iipi\create\createprojects_wstcref.txt
C:\ARI-CREATE Source\create\src\com\iipi\create\DerivedPropertySet_java.txt
C:\ARI-CREATE Source\create\src\com\iipi\create\IndexedPropertyList_java.txt
C:\ARI-CREATE Source\create\src\com\iipi\create\layer_xml.txt
C:\ARI-CREATE Source\create\src\com\iipi\create\nb
C:\ARI-CREATE Source\create\src\com\iipi\create\project
C:\ARI-CREATE Source\create\src\com\iipi\create\resources
C:\ARI-CREATE Source\create\src\com\iipi\create\swing
C:\ARI-CREATE Source\create\src\com\iipi\create\nb\AAREditor_java.txt
C:\ARI-CREATE Source\create\src\com\iipi\create\nb\ActionPlanEditor_java.txt
C:\ARI-CREATE Source\create\src\com\iipi\create\nb\AddActionPlanAction_java.txt
C:\ARI-CREATE
Source\create\src\com\iipi\create\nb\AddAnalysisGroupAction_java.txt
C:\ARI-CREATE Source\create\src\com\iipi\create\nb\AddEventAction_java.txt
C:\ARI-CREATE
Source\create\src\com\iipi\create\nb\AddExpectationAction_java.txt
C:\ARI-CREATE
Source\create\src\com\iipi\create\nb\AddLearningObjectiveAction_java.txt
C:\ARI-CREATE
Source\create\src\com\iipi\create\nb\AddLearningStepAction_java.txt
C:\ARI-CREATE Source\create\src\com\iipi\create\nb\AddModuleAction_java.txt
C:\ARI-CREATE Source\create\src\com\iipi\create\nb\AddNeedAction_java.txt
C:\ARI-CREATE Source\create\src\com\iipi\create\nb\AddReferenceAction_java.txt
C:\ARI-CREATE Source\create\src\com\iipi\create\nb\AddSceneAction_java.txt
C:\ARI-CREATE Source\create\src\com\iipi\create\nb\AddTaskAction_java.txt
C:\ARI-CREATE Source\create\src\com\iipi\create\nb\AnalysisEditor_java.txt
C:\ARI-CREATE Source\create\src\com\iipi\create\nb\AnalysisEnv_java.txt
C:\ARI-CREATE
Source\create\src\com\iipi\create\nb\AssessmentPlanEditor_java.txt
C:\ARI-CREATE
Source\create\src\com\iipi\create\nb\CloneableEditorSupportEnv_java.txt
C:\ARI-CREATE Source\create\src\com\iipi\create\nb\ExplorerPanel_java.txt
C:\ARI-CREATE Source\create\src\com\iipi\create\nb\MasterDetailEditor_java.txt
C:\ARI-CREATE Source\create\src\com\iipi\create\nb\MissionEditor_java.txt
C:\ARI-CREATE Source\create\src\com\iipi\create\nb\ModuleEditor_java.txt
C:\ARI-CREATE Source\create\src\com\iipi\create\nb\Navigator_java.txt
C:\ARI-CREATE Source\create\src\com\iipi\create\nb\nodes
C:\ARI-CREATE Source\create\src\com\iipi\create\nb\OpenProjectAction_java.txt
C:\ARI-CREATE Source\create\src\com\iipi\create\nb\SaveAsProjectAction_java.txt
C:\ARI-CREATE Source\create\src\com\iipi\create\nb\SaveProjectAction_java.txt
C:\ARI-CREATE Source\create\src\com\iipi\create\nb\SetupEditor_java.txt
C:\ARI-CREATE Source\create\src\com\iipi\create\nb\StoryboardEditor_java.txt
C:\ARI-CREATE
Source\create\src\com\iipi\create\nb\TrainingMatrixEditor_java.txt
C:\ARI-CREATE
Source\create\src\com\iipi\create\nb\TrainingOutlineEditor_java.txt
C:\ARI-CREATE Source\create\src\com\iipi\create\nb\ViewNotesAction_java.txt
C:\ARI-CREATE Source\create\src\com\iipi\create\nb\ViewProjectsAction_java.txt
C:\ARI-CREATE
Source\create\src\com\iipi\create\nb\nodes\ActionPlanNode_java.txt
C:\ARI-CREATE
Source\create\src\com\iipi\create\nb\nodes\ActionPlansNode_java.txt
C:\ARI-CREATE
Source\create\src\com\iipi\create\nb\nodes\AnalysisGroupNode_java.txt
C:\ARI-CREATE Source\create\src\com\iipi\create\nb\nodes\AnalysisNode_java.txt
C:\ARI-CREATE Source\create\src\com\iipi\create\nb\nodes\BeanNode_java.txt
C:\ARI-CREATE Source\create\src\com\iipi\create\nb\nodes\EventNode_java.txt
C:\ARI-CREATE
Source\create\src\com\iipi\create\nb\nodes\ExpectationNode_java.txt
C:\ARI-CREATE
Source\create\src\com\iipi\create\nb\nodes\LearningObjectiveNode_java.txt
C:\ARI-CREATE
Source\create\src\com\iipi\create\nb\nodes\LearningStepNode_java.txt
C:\ARI-CREATE Source\create\src\com\iipi\create\nb\nodes\ModuleNode_java.txt
C:\ARI-CREATE Source\create\src\com\iipi\create\nb\nodes\ModulesNode_java.txt
C:\ARI-CREATE Source\create\src\com\iipi\create\nb\nodes\NeedNode_java.txt
C:\ARI-CREATE Source\create\src\com\iipi\create\nb\nodes\NodeAdapter_java.txt
C:\ARI-CREATE Source\create\src\com\iipi\create\nb\nodes\OpenableNode_java.txt
C:\ARI-CREATE
Source\create\src\com\iipi\create\nb\nodes\OverviewAnalysisNode_java.txt
C:\ARI-CREATE Source\create\src\com\iipi\create\nb\nodes\ProjectNode_java.txt
C:\ARI-CREATE Source\create\src\com\iipi\create\nb\nodes\ReferenceNode_java.txt
C:\ARI-CREATE Source\create\src\com\iipi\create\nb\nodes\SceneNode_java.txt
C:\ARI-CREATE Source\create\src\com\iipi\create\nb\nodes\SetupNode_java.txt
C:\ARI-CREATE
Source\create\src\com\iipi\create\nb\nodes\StoryboardNode_java.txt
C:\ARI-CREATE Source\create\src\com\iipi\create\nb\nodes\TaskNode_java.txt
C:\ARI-CREATE
Source\create\src\com\iipi\create\nb\nodes\TrainingMatrixNode_java.txt
C:\ARI-CREATE Source\create\src\com\iipi\create\project\AAR_java.txt
C:\ARI-CREATE Source\create\src\com\iipi\create\project\ActionPlan_java.txt
C:\ARI-CREATE Source\create\src\com\iipi\create\project\AnalysisGroup_java.txt
C:\ARI-CREATE Source\create\src\com\iipi\create\project\Analysis_java.txt
C:\ARI-CREATE
Source\create\src\com\iipi\create\project\AssociationManager_java.txt
C:\ARI-CREATE Source\create\src\com\iipi\create\projeot\Association_java.txt
C:\ARI-CREATE Source\create\src\com\iipi\create\project\BaseBean_java.txt
C:\ARI-CREATE Source\create\src\com\iipi\create\project\Event_java.txt
C:\ARI-CREATE Source\create\src\com\iipi\create\project\Expectation_java.txt
C:\ARI-CREATE Source\create\src\com\iipi\create\project\Goal_java.txt
C:\ARI-CREATE Source\create\src\com\iipi\create\project\Implementation_java.txt
C:\ARI-CREATE
Source\create\src\com\iipi\create\project\LearningObjective_java.txt
C:\ARI-CREATE Source\create\src\com\iipi\create\project\LearningStep_java.txt
C:\ARI-CREATE Source\create\src\com\iipi\create\project\Module_java.txt
C:\ARI-CREATE Source\create\src\com\iipi\create\project\NamedBean_java.txt
C:\ARI-CREATE Source\create\src\com\iipi\create\project\Named_java.txt
C:\ARI-CREATE Source\create\src\com\iipi\create\project\Need_java.txt
C:\ARI-CREATE Source\create\src\com\iipi\create\project\Note_java.txt
C:\ARI-CREATE Source\create\src\com\iipi\create\project\Project_java.txt
C:\ARI-CREATE Source\create\src\com\iipi\create\project\Reference_java.txt
C:\ARI-CREATE Source\create\src\com\iipi\create\project\Scene_java.txt
C:\ARI-CREATE Source\create\src\com\iipi\create\project\Setup_java.txt
C:\ARI-CREATE Source\create\src\com\iipi\create\project\Storyboard_java.txt
C:\ARI-CREATE Source\create\src\com\iipi\create\project\Task_java.txt
C:\ARI-CREATE
Source\create\src\com\iipi\create\project\TrainingOutline_java.txt
C:\ARI-CREATE Source\create\src\com\iipi\create\project\User_java.txt
C:\ARI-CREATE Source\create\src\com\iipi\create\swing\ActionPlanEditor_java.txt
C:\ARI-CREATE
Source\create\src\com\iipi\create\swing\AnalysisGroupEditor_java.txt
C:\ARI-CREATE Source\create\src\com\iipi\create\swing\BeanEditorPanel_java.txt
C:\ARI-CREATE Source\create\src\com\iipi\create\swing\BeanEditor_java.txt
C:\ARI-CREATE Source\create\src\com\iipi\create\swing\EditorPanel_java.txt
C:\ARI-CREATE Source\create\src\com\iipi\create\swing\EventEditor_java.txt
C:\ARI-CREATE
Source\create\src\com\iipi\create\swing\ExpectationEditor_java.txt
C:\ARI-CREATE
Source\create\src\com\iipi\create\swing\LearningObjectiveEditor_java.txt
C:\ARI-CREATE
Source\create\src\com\iipi\create\swing\LearningStepEditor_java.txt
C:\ARI-CREATE Source\create\src\com\iipi\create\swing\NeedEditor_java.txt
C:\ARI-CREATE Source\create\src\com\iipi\create\swing\ReferenceEditor_java.txt
C:\ARI-CREATE Source\create\src\com\iipi\create\swing\SceneEditor_java.txt
C:\ARI-CREATE Source\create\src\com\iipi\create\swing\StoryboardEditor_java.txt
C:\ARI-CREATE Source\create\src\com\iipi\create\swing\TaskEditor_java.txt
C:\ARI-CREATE Source\create\src\com\iipi\create\swing\TwoListEditor_java.txt
C:\ARI-CREATE Source\create\test\unit
C:\ARI-CREATE Source\create\test\unit\src

What is claimed is:

1. A computer system for authoring an application for both a mixed reality environment and a video game environment, said computer system comprising:
an asset management software program including a plurality of asset data objects relating to an environment, each of said plurality of asset data objects including objects relating to at least one of a three dimensional model, an image, text, sound, a button, and an action setting;
a design organization software program including at least one of a plurality of interfaces, said design organization software program associating design information with said interface and a desired environment; and
an editor program for creating the desired environment from said asset management software program, said editor program configuring the environment so that the environment is usable by one of a mixed reality device and a video game device.

2. The computer system of claim 1 further including a runtime software program for presenting a mixed reality interface to an end user.

3. The computer system of claim 2 wherein said project editor is capable of modifying the environment concurrent with said asset management software program providing the environment to an end user.

4. The computer system of claim 2 wherein said editor includes a simulator capable of presenting the environment to the operator of the computer separately from said runtime software program, said simulator simulating the presentation of the environment to the end user.

5. The computer system of claim 1 wherein said editor is further capable of creating a asset data object that may be used by multiple environments.

6. The computer system of claim 1 wherein said asset management software program includes a design document generation program for creating a design document for production purposes from said design information.

7. The computer system of claim 1 wherein said asset management software program includes a lesson plan generation program for creating a lesson plan.

8. A computer system for creating a mixed reality or video game environment, said computer system comprising:
an asset management software program including a plurality of asset data objects relating to the environment, each of said plurality of asset data objects including objects relating to at least one of a three dimensional model, an image, text, sound, a button, and an action setting;
a project organization software program including at least one of a plurality of interfaces, said project organization software program capable of creating a project data object referencing said asset data objects, said interfaces, and a project data object; and
a project editor capable of modifying said project organization software program according to operator instructions.

9. The computer system of claim 8 further including a runtime software program for presenting a mixed reality interface to an end user.

10. The computer system of claim 9 wherein said project editor is capable of modifying said project organization software program concurrent with said asset management software program providing a mixed reality environment to an end user.

11. The computer system of claim 9 further comprising an end user monitoring software program adapted to record operations of the end user with the mixed reality interface.

12. The computer system of claim 10 wherein said project editor includes a project simulator capable of presenting a mixed reality interface to the operator separately from said runtime software program, said project simulator capable of simulating the presentation of the mixed reality interface to the end user.

13. The computer system of claim 8 wherein said project editor is further capable of creating a mixed reality interface that may be used by multiple project data objects.

14. The computer system of claim 8 wherein said asset management software program includes providing an association between design information relating to the mixed reality environment and one of said interfaces.

15. The computer system of claim 14 wherein said asset management software program includes a design document generation program for creating a design document for production purposes from said design information.

16. The computer system of claim 14 wherein said asset management software program includes a lesson plan generation program for creating a lesson plan.

17. In computer, a method of generating a mixed reality or video game environment, said method comprising the steps of:
creating an interface;
organizing the interface into at least one project;
presenting the project to a user; and
editing the project based on reactions of the user to the presentation of the project.

18. The method of claim 17 wherein the presenting step and the editing step may occur concurrently.

19. The method of claim 17 further including the step of associating design information with the mixed reality interface.

20. A machine-readable program storage device for storing encoded instructions for a method of generating a mixed reality or video game environment, said method comprising the steps of:
creating an interface;
organizing the interface into at least one project;
presenting the project to a user; and
editing the project based on reactions of the user to the presentation of the project.

21. The machine-readable program storage device of claim 20 wherein said method has instructions for the presenting step and the editing step to occur concurrently.

22. The machine-readable program storage device of claim 20 wherein said method has instructions for the further step of associating design information with the mixed reality interface.
